(19) United States
(12) Patent Application Publication
(10) Pub. No.: US 2010/0099828 A1
(43) Pub. Date: Apr. 22, 2010

(54) Clear Binary Blends of Aliphatic Polyesters and Aliphatic-Aromatic Polyesters

(75) Inventors: Gary Michael Stack, Kingsport, TN (US); Wesley Raymond Hale, Kingsport, TN (US)

Correspondence Address: LOUIS N. MORENO, P.O. BOX 511 , B-75, KINGSPORT, TN, 37662, US

(73) Assignee: EASTMAN CHEMICAL COMPANY, Kingsport, TN (US)

(21) Appl. No.: 12/254,894

(22) Filed: Oct. 21, 2008

(51) Int. Cl. C08L 67/02

(52) U.S. Cl. 525/418

(57) ABSTRACT

This invention relates to a polymer blend comprising:
(A) 5 to 95 weight % of at least one aliphatic-aromatic copolyester which comprises:
   (i) a dicarboxylic acid component comprising 70 to 100 mole % terephthalic acid residues; and
   (ii) a glycol component comprising:
      (a) 15 to 50 mole % of 2,2,4,4-tetramethyl-1,3-cyclobutanediol residues; and
      (b) 50 to 80 mole % of cyclohexanedimethanol residues;
wherein the total mole % of the dicarboxylic acid component is 100 mole % and wherein the total mole % of the glycol component is 100 mole %; and
(B) 5 to 95 weight % of at least one aliphatic polyester which comprises:
   (i) a dicarboxylic acid component comprising
      (a) 70 to 100 mole % of cyclohexanedicarboxylic acid residues; and
      (b) 0 to 30 mole % of additional aliphatic acid residues;
      (c) 0 to 10 mole % of aromatic acid residues; and
   (ii) a glycol component comprising cyclohexanedimethanol residues;
wherein the total mole % of the dicarboxylic acid component is 100 mole % and wherein the total mole % of the glycol component is 100 mole %.

### FIELD OF THE INVENTION

This invention pertains to polymer blends prepared by blending polyesters prepared from terephthalic acid, 100 to 5 mole % 2,2,4,4-tetramethy-1,3-cyclobutanediol and 0 to 95 mole % 1,4-cyclohexanedimethanol with polyesters comprising 1,4 cyclohexane dicarboxylic acid and 1,4 cyclohexanedimethanol (PCCD). The composition of the blend can include up to about 95 weight % PCCD. These blends have a combination of clarity and toughness making the materials particularly useful in engineering molding plastics and packaging.

### BACKGROUND OF THE INVENTION

Clear blends of two polymers are rare. Scott et al. in U.S. Pat. No. 6,005,059 reports on blends of certain polycarbonates with certain polyesters containing 2,2,4,4-tetramethy-1,3-cyclobutanediol. Certain ones of these blends were clear and exhibited a single glass transition temperature indicating the existence of a single solid phase.

Scott et al. in U.S. Pat. No. 6,011,124 and U.S. Pat. No. 6,037,424 reports on blends of certain polycarbonates with certain polyesters containing aromatic dicarboxylic acids, 2,2,4,4-tetramethy-1,3-cyclobutanediol and ethylene glycol. Certain of these blends were clear and exhibited a single glass transition temperature indicating the existence of a single solid phase.

Scott et al. in U.S. Pat. No. 6,043,322 reports on blends of certain polycarbonates with certain polyesters containing aromatic dicarboxylic acids, 2,2,4,4-tetramethy-1,3-cyclobutanediol and cyclohexanedimethanol. Certain of these blends were clear and exhibited a single glass transition temperature indicating the existence of a single solid phase.

Scott et al in U.S. Pat. No.5,498,688 reports on blends of acrylics with polyesters containing 2,2,4,4-tetramethy-1,3-cyclobutanediol.

U.S. Pat. No. 5,486,562 to Borman et al. discloses blends of poly(alkylene cyclohexanedicarboxylate) and amorphous copolymer resins.

U.S. Pat. No. 5,498,668 to Scott discloses blends of an aliphatic or cycloaliphatic polyester with an acrylic polymer.

European Patent Application 0 902 052 A1 to Hoefflin et al. discloses an aliphatic polyester-acrylic blend molding composition.

Compositions comprising a polycarbonate, a cycloaliphatic resin, an ultraviolet light absorber and a catalysts quencher are disclosed in U.S. Pat. No. No. 5,907026 to Factor et al.

Compositions comprising a polycarbonate and a cycloaliphatic resin for use in optical data storage are disclosed in U.S. Pat. No. 6,221,556 to Gallucci et al.

There is a need in the art for a polymer blend that is useful in molding plastics, fibers, and films and which also have excellent clarity, good heat resistance and good toughness.

### SUMMARY OF THE INVENTION

This invention provides blends of high molecular weight polyesters comprising units of terephthalic acid, 2,2,4,4-tetramethy-1,3-cyclobutanediol and 1,4-cyclohexanedimethanol with PCCD having excellent clarity, good heat resistance and good toughness.

This invention relates to a polymer blend comprising:
(A) 5 to 95 weight % of at least one aliphatic-aromatic copolyester which comprises:
   (i) a dicarboxylic acid component comprising terephthalic acid residues; and
   (ii) a glycol component comprising:
      (a) 5 to 100 mole % of 2,2,4,4-tetramethyl-1,3-cyclobutanediol residues; and
      (b) 0 to 95 mole % of cyclohexanedimethanol residues;
wherein the total mole % of the dicarboxylic acid component is 100 mole % and wherein the total mole % of the glycol component is 100 mole %; and
(B) 5 to 95 weight % of at least one aliphatic polyester which comprises:
   (i) a dicarboxylic acid component comprising cyclohexanedicarboxylic acid residues; and
   (ii) a glycol component comprising cyclohexanedimethanol residues;
wherein the total mole % of the dicarboxylic acid component is 100 mole % and wherein the total mole % of the glycol component is 100 mole %.

This invention also relates to a polymer blend wherein said aliphatic-aromatic polyester comprises about 70 to about 100 mole percent, based on the total moles of diacid residues, of the residues of terephthalic acid, isophthalic acid, or combinations thereof; and about 10 to about 90 mole percent, based on the total moles of diol residues, of the residues 1,4-cyclohexanedimethanol, about 10 to about 90 mole percent of the residues of 2,2,4,4-tetramethyl-1,3-cyclobutanediol, and 0 to about 80 mole percent of the residues of neopentyl glycol, diethylene glycol, ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 1,3-cyclohexanedimethanol, bisphenol A, polyalkylene glycol, or combinations thereof.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 5 to 50 mole % of 2,2,4,4-tetramethyl-1,3-cyclobutanediol residues; and
      (ii) 50 to 95 mole % of cyclohexanedimethanol residues;
wherein the total mole % of the dicarboxylic acid component is 100 mole % and wherein the total mole % of the glycol component is 100 mole %. and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
   wherein the total mole % of the dicarboxylic acid component is 100 mole %, and the total mole % of the diol component is 100 mole %.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 10 to 30 mole % of 2,2,4,4-tetramethyl-1,3-cyclobutanediol residues; and
      (ii) 70 to 90 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.50 to 1.0 dL/g as determined in 60/40 (wt/wt) phenol/tetrachloroethane at a concentration of 0.25 g/50 ml at 25° C.; and wherein the aliphatic-aromatic polyester has a Tg from 85 to 120° C. In one embodiment, the Tg of the—aliphatic-aromatic polyester is from 100 to 120° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 15 to 25 mole % of 2,2,4,4-tetramethyl-1,3-cyclobutanediol residues; and
      (ii) 75 to 85 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
   wherein the total mole % of the dicarboxylic acid component is 100 mole %, and the total mole % of the diol component is 100 mole %; and
wherein the inherent viscosity of the aliphatic-aromatic polyester is from 0.50 to 1.0 dL/g as determined in 60/40 (wt/wt) phenol/tetrachloroethane at a concentration of 0.25 g/50 ml at 25° C.; and
wherein the aliphatic-aromatic polyester has a Tg from 85 to 120° C. In one embodiment, the Tg of the aliphatic-aromatic polyester is from 100 to 120° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 15 to 25 mole % of 2,2,4,4-tetramethyl-1,3-cyclobutanediol residues; and
      (ii) 75 to 85 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and and wherein the inherent viscosity of the aliphatic-aromatic polyester is from 0.50 to 0.75 dL/g as determined in 60/40 (wt/wt) phenol/tetrachloroethane at a concentration of 0.25 g/50 ml at 25° C.; and
wherein the aliphatic-aromatic polyester has a Tg from 85 to 120° C. In one embodiment, the Tg of the aliphatic-aromatic polyester is from 100 to 120° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 5 to less than 50 mole % of 2,2,4,4-tetramethyl-1,3-cyclobutanediol residues; and
      (ii) greater than 50 to 95 mole % of cyclohexanedimethanol residues; wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
   wherein the total mole % of the dicarboxylic acid component is 100 mole %, and the total mole % of the diol component is 100 mole %; and
wherein the inherent viscosity of the aliphatic-aromatic polyester is from 0.50 to 0.75 dL/g as determined in 60/40 (wt/wt) phenol/tetrachloroethane at a concentration of 0.25 g/50 ml at 25° C.; and
wherein the aliphatic-aromatic polyester has a Tg from 85 to 120° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 5 to less than 50 mole % of 2,2,4,4-tetramethyl-1,3-cyclobutanediol residues; and
      (ii) greater than 50 to 95 mole % of cyclohexanedimethanol residues;
      wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.60 to 0.75 dL/g as determined in 60/40 (wt/wt) phenol/tetrachloroethane at a concentration of 0.25 g/50 ml at 25° C.; and wherein the aliphatic-aromatic polyester has a Tg from 85 to 120° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 10 to 30 mole % of 2,2,4,4-tetramethyl-1,3-cyclobutanediol residues; and
      (ii) 70 to 90 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
   wherein the total mole % of the dicarboxylic acid component is 100 mole %, and the total mole % of the diol component is 100 mole %; and
wherein the inherent viscosity of the aliphatic-aromatic polyester is from 0.5 to 0.8 dL/g as determined in 60/40 (wt/wt) phenol/tetrachloroethane at a concentration of 0.25 g/50 ml at 25° C.; and wherein the aliphatic-aromatic polyester has a Tg from 85 to 120° C. In one embodiment, the Tg of the aliphatic-aromatic polyester is from 100 to 120° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 10 to 30 mole % of 2,2,4,4-tetramethyl-1,3-cyclobutanediol residues; and
      (ii) 70 to 90 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.50 to 0.75 dL/g as determined in 60/40 (wt/wt) phenol/tetrachloroethane at a concentration of 0.25 g/50 ml at 25° C.; and wherein the aliphatic-aromatic polyester has a Tg from 85 to 120° C. In one embodiment, the Tg of the aliphatic-aromatic polyester is from 100 to 120° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 25 to 35 mole % of 2,2,4,4-tetramethyl-1,3-cyclobutanediol residues;
      (ii) 65 to 75 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.40 to 0.80 dL/g as determined in 60/40 (wt/wt) phenol/tetrachloroethane at a concentration of 0.25 g/50 ml at 25° C.; and wherein the aliphatic-aromatic polyester has a Tg from 100 to 120° C.

In one aspect, the polymer blend of the invention comprises:
(II) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 25 to 35 mole % of 2,2,4,4-tetramethyl-1,3-cyclobutanediol residues;
      (ii) 65 to 75 mole % of cyclohexanedimethanol residues;
   wherein the total mole % of the dicarboxylic acid component is 100 mole %, and the total mole % of the diol component is 100 mole %; and
II( ) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.6 to 0.68 dL/g as determined in 60/40 (wt/wt) phenol/tetrachloroethane at a concentration of 0.25 g/50 ml at 25° C.; and wherein the aliphatic-aromatic polyester has a Tg from 110 to 130° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 30 to 35 mole % of 2,2,4,4-tetramethyl-1,3-cyclobutanediol residues;
      (ii) 65 to 70 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.4 to 0.8 dL/g as determined in 60/40 (wt/wt) phenol/tetrachloroethane at a concentration of 0.25 g/50 ml at 25° C.; and wherein the aliphatic-aromatic polyester has a Tg from 110 to 130° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 30 to 35 mole % of 2,2,4,4-tetramethyl-1,3-cyclobutanediol residues;
      (ii) 65 to 70 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.6 to 0.68 dL/g as determined in 60/40 (wt/wt) phenol/tetrachloroethane at a concentration of 0.25 g/50 ml at 25° C.; and wherein the aliphatic-aromatic polyester has a Tg from 110 to 130° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 30 to 40 mole % of 2,2,4,4-tetramethyl-1,3-cyclobutanediol residues;
      (ii) 60 to 70 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.6 to 0.68 dL/g as determined in 60/40 (wt/wt) phenol/tetrachloroethane at a concentration of 0.25 g/50 ml at 25° C.; and wherein the aliphatic-aromatic polyester has a Tg from 110 to 120° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 20 to 35 mole % of 2,2,4,4-tetramethyl-1,3-cyclobutanediol residues;
      (ii) 65 to 80 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.55 to 0.80 dL/g as determined in 60/40 (wt/wt) phenol/tetrachloroethane at a concentration of 0.25 g/50 ml at 25° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 20 to 35 mole % of 2,2,4,4-tetramethyl-1,3-cyclobutanediol residues;
      (ii) 65 to 80 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.55 to 0.75 dL/g as determined in 60/40 (wt/wt) phenol/tetrachloroethane at a concentration of 0.25 g/50 ml at 25° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 20 to 35 mole % of 2,2,4,4-tetramethyl-1,3-cyclobutanediol residues;
      (ii) 65 to 80 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the aliphatic-aromatic polyester has a Tg from 100 to 125° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 20 to 25 mole % of 2,2,4,4-tetramethyl-1,3-cyclobutanediol residues;
      (ii) 75 to 80 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.69 to 0.75 dL/g as determined in 60/40 (wt/wt) phenol/tetrachloroethane at a concentration of 0.25 g/50 ml at 25° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 20 to 25 mole % of 2,2,4,4-tetramethyl-1,3-cyclobutanediol residues;
      (ii) 75 to 80 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and
wherein the inherent viscosity of the aliphatic-aromatic polyester is from 0.69 to 0.75 dL/g as determined in 60/40 (wt/wt) phenol/tetrachloroethane at a concentration of 0.25 g/50 ml at 25° C.; and wherein the aliphatic-aromatic polyester has a Tg from 105 to 112° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 15 to 25 mole % of 2,2,4,4-tetramethyl-1,3-cyclobutanediol residues;
      (ii) 75 to 85 mole % of cyclohexanedimethanol residues;
   wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the inherent viscosity of the aliphatic-aromatic polyester is from 0.6 to 0.75 dL/g as determined in 60/40 (wt/wt) phenol/tetrachloroethane at a concentration of 0.25 g/50 ml at 25° C.; and wherein the aliphatic-aromatic polyester has a Tg from 100 to 120° C.

In one aspect, the polymer blend of the invention comprises:
(I) 5 to 95 weight % of at least one aliphatic-aromatic polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 1 to less than 90 mole % 2,2,4,4-tetramethyl-1,3-cyclobutanediol residues; and
      (ii) about 0 to about 89 mole % cyclohexanedimethanol residues;
      (iii) greater than 10 mole % ethylene glycol residues, and
      (iv) less than about 2 mole % of a modifying glycol having from 3 to 16 carbon atoms;
   (c) titanium atoms and phosphorus atoms; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the total mole % of the dicarboxylic acid component is 100 mole %, and
wherein the total mole % of the glycol component is 100 mole %; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the inherent viscosity of the aliphatic-aromatic polyester is from 0.50 to 1.2 dL/g as determined in 60/40 (wt/wt) phenol/tetrachloroethane at a concentration of 0.25 g/50 ml at 25° C.

In one aspect, the polymer blend of the invention comprises:
(I) 5 to 95 weight % of at least one aliphatic-aromatic polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 20 to about 40 mole % 2,2,4,4-tetramethyl-1,3-cyclobutanediol residues; and
      (ii) about 20 to about 40 mole % cyclohexanedimethanol residues;
      (iii) ethylene glycol residues, and
      (iv) less than about 2 mole % of a modifying glycol having from 3 to 16 carbon atoms;
   (c) titanium atoms and phosphorus atoms;
   (d) wherein the total mole % of the dicarboxylic acid component is 100 mole %, and wherein the total mole % of the glycol component is 100 mole %; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the inherent viscosity of the aliphatic-aromatic polyester is from 0.50 to 1.2 dL/g as determined in 60/40 (wt/wt) phenol/tetrachloroethane at a concentration of 0.25 g/50 ml at 25° C.

In one aspect, the polymer blend of the invention comprises:
(I) 5 to 95 weight % of at least one aliphatic-aromatic polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 20 to about 40 mole % 2,2,4,4-tetramethyl-1,3-cyclobutanediol residues; and
      (ii) about 20 to about 40 mole % cyclohexanedimethanol residues;
      (iii) ethylene glycol residues, and
      (iv) less than about 2 mole % of a modifying glycol having from 3 to 16 carbon atoms;
   (c) titanium atoms and phosphorus atoms;
   wherein the total mole % of the dicarboxylic acid component is 100 mole %; and wherein the total mole % of the glycol component is 100 mole %; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the inherent viscosity of the aliphatic-aromatic polyester is from 0.50 to 1.2 dL/g as determined in 60/40 (wt/wt) phenol/tetrachloroethane at a concentration of 0.25 g/50 ml at 25° C.; and
optionally, wherein at least one branching agent is added before and/or during polymerization of the polyester.

In one aspect, the polymer blend of the invention comprises:
(I) 5 to 95 weight % of at least one aliphatic-aromatic polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
   (i) about 20 to about 40 mole % 2,2,4,4-tetramethyl-1,3-cyclobutanediol residues; and
   (ii) about 20 to about 40 mole % cyclohexanedimethanol residues;
   (iii) ethylene glycol residues, and
   (iv) less than about 2 mole % of a modifying glycol having from 3 to 16 carbon atoms;
   (c) titanium atoms and phosphorus atoms;
wherein the total mole % of the dicarboxylic acid component is 100 mole %, and
wherein the total mole % of the glycol component is 100 mole %; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the inherent viscosity of the aliphatic-aromatic polyester is from 0.50 to 1.2 dL/g as determined in 60/40 (wt/wt) phenol/tetrachloroethane at a concentration of 0.25 g/50 ml at 25° C.; and
wherein the aliphatic-aromatic polyester has at least one of the following properties chosen from: a Tg of from about 100 to about 110° C. as measured by a TA 2100 Thermal Analyst Instrument at a scan rate of 20° C./min, a flexural modulus at 23° C. equal to or greater than 290,000 psi as defined by ASTM D790, and a notched Izod impact strength equal to or greater than 10 ft-lb/in according to ASTM D256 with a 10-mil notch using a ⅛-inch thick bar at 23° C.

In one aspect, the polymer blend of the invention comprises:
(I) 5 to 95 weight % of at least one aliphatic-aromatic polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 20 to about 40 mole % 2,2,4,4-tetramethyl-1,3-cyclobutanediol residues; and
      (ii) about 20 to about 40 mole % cyclohexanedimethanol residues;
      (iii) ethylene glycol residues, and
      (iv) less than about 2 mole % of a modifying glycol having from 3 to 16 carbon atoms;
   (c) titanium atoms and phosphorus atoms; and
wherein the total mole % of the dicarboxylic acid component is 100 mole %, and
wherein the total mole % of the glycol component is 100 mole %;
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the sum of the mole percentages of 2,2,4,4-tetramethyl-1,3-cyclobutanediol and cyclohexanedimethanol in the aliphatic-aromatic polyester is from 40 to less than 70 mole % of the total mole % of the glycol component;
wherein the inherent viscosity of the aliphatic-aromatic polyester is from 0.50 to 1.2 dL/g as determined in 60/40 (wt/wt) phenol/tetrachloroethane at a concentration of 0.25 g/50 ml at 25° C.; and
wherein the aliphatic-aromatic polyester has at least one of the following properties chosen from: a Tg of from about 100 to about 110° C. as measured by a TA 2100 Thermal Analyst Instrument at a scan rate of 20° C./min, a flexural modulus at 23° C. equal to or greater than 290,000 psi as defined by ASTM D790, and a notched Izod impact strength equal to or greater than 10 ft-lb/in according to ASTM D256 with a 10-mil notch using a ⅛-inch thick bar at 23° C.

In one aspect, the polymer blend of the invention comprises:
(I) 5 to 95 weight % of at least one aliphatic-aromatic polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 20 to about 40 mole % 2,2,4,4-tetramethyl-1,3-cyclobutanediol residues; and
      (ii) about 20 to about 40 mole % cyclohexanedimethanol residues;
      (iii) ethylene glycol residues, and
      (iv) less than about 2 mole % of a modifying glycol having from 3 to 16 carbon atoms;
   (c) optionally, at least one branching agent;
   (d) wherein the total mole % of the dicarboxylic acid component is 100 mole %, and the total mole % of the diol component is 100 mole %; and titanium atoms and phosphorus atoms;
wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the sum of the mole percentages of 2,2,4,4-tetramethyl-1,3-cyclobutanediol and cyclohexanedimethanol of the aliphatic-aromatic polyester is from 40 to less than 70 mole % of the total mole % of the glycol component, and
wherein the inherent viscosity of the aliphatic-aromatic polyester is from 0.50 to 1.2 dL/g as determined in 60/40 (wt/wt) phenol/tetrachloroethane at a concentration of 0.25 g/50 ml at 25° C.

In all aspects of the invention, the aliphatic polyester may also comprise one of several compositions.

In one aspect of the invention, the aliphatic polyester comprises:
(A) a dicarboxylic acid component comprising:
   (i) about 70 to about 100 mole % of cyclohexanedicarboxylic acid residues;
   (ii) about 0 to about 30 mole % of aliphatic dicarboxylic acid residues, other than cyclohexanedicarboxylic acid residues, having up to 20 carbon atoms; and
   (iii) 0 to 10 mole % of aromatic dicarboxylic acid residues having up to 20 carbon atoms; and
(B) a glycol component comprising:
   (i) 0 to 20 mole % 2,2,4,4-tetramethyl-1,3-cyclobutanediol residues; and
   (ii) 80 to 100 mole % cyclohexanedimethanol residues;
wherein the total mole % of the dicarboxylic acid component is equal to 100 mole %;
wherein the total mole % of the glycol component is equal to 100 mole %;
wherein the inherent viscosity of the aliphatic polyester is from 0.35 to 1.2 dL/g as determined in 60/40 (wt/wt) phenol/tetrachloroethane at a concentration of 0.25 g/50 ml at 25° C.; and
wherein the aliphatic polyester has a glass transition temperature of from greater than 60° C. to 155° C.

In one aspect of the invention, the aliphatic polyester comprises:
(A) a dicarboxylic acid component comprising:
   (i) about 70 to about 100 mole % of cyclohexanedicarboxylic acid residues;
   (ii) about 0 to about 30 mole % of aliphatic dicarboxylic acid residues, other than cyclohexanedicarboxylic acid residues, having up to 20 carbon atoms; and
   (iii) 0 to 10 mole % of aromatic dicarboxylic acid residues having up to 20 carbon atoms; and
(B) a glycol component comprising:
   (i) 50 to 90 mole % 2,2,4,4-tetramethyl-1,3-cyclobutanediol residues; and
   (ii) 10 to 50 mole % cyclohexanedimethanol residues;
wherein the total mole % of the dicarboxylic acid component is equal to 100 mole %;
wherein the total mole % of the glycol component is equal to 100 mole %;
wherein the inherent viscosity of the aliphatic polyester is from 0.5 to 1.2 dL/g as determined in 60/40 (wt/wt) phenol/tetrachloroethane at a concentration of 0.25 g/50 ml at 25° C.; and
wherein the aliphatic polyester has a glass transition temperature of from greater than 60° C. to 155° C.

In one aspect, the aliphatic-aromatic polyesters useful in the invention and/or the aliphatic polyesters useful in the invention can comprise at least one phosphate ester described herein.

In one aspect, the aliphatic-aromatic polyesters useful in the invention and/or the aliphatic polyesters useful in the invention can comprise phosphorus atoms.

In one aspect, the aliphatic-aromatic polyesters useful in the invention and/or the aliphatic polyesters useful in the invention can comprise tin atoms.

In one aspect, the aliphatic-aromatic polyesters useful in the invention and/or the aliphatic polyesters useful in the invention contain ethylene glycol residues.

In one aspect, the aliphatic-aromatic polyesters useful in the invention and/or the aliphatic polyesters useful in the invention contain no ethylene glycol residues.

In one aspect, the the aliphatic-aromatic polyesters useful in the invention and/or the aliphatic polyesters useful in the invention contain no branching agent, or alternatively, at least one branching agent is added either prior to or during polymerization of the polyester.

In one aspect, the aliphatic-aromatic polyesters useful in the invention and/or the aliphatic polyesters useful in the invention contain at least one branching agent without regard to the method or sequence in which it is added.

In one aspect, the aliphatic-aromatic polyesters useful in the invention and/or the aliphatic polyesters useful in the invention may comprise at least one tin compound and at least one titanium compound.

In one aspect, the aliphatic-aromatic polyesters useful in the invention and/or the aliphatic polyesters useful in the invention may comprise at least one phosphorus containing compound.

In one aspect, the aliphatic-aromatic polyesters useful in the invention and/or the aliphatic polyesters useful in the invention may comprise at least one aryl phosphate ester.

In one aspect, any of the aliphatic-aromatic polyesters may comprise at least one tin compound and, optionally, at least one catalyst chosen from titanium, gallium, zinc, antimony, cobalt, manganese, magnesium, germanium, lithium, aluminum compounds and an aluminum compound with lithium hydroxide or sodium hydroxide.

In one embodiment, any of the aliphatic-aromatic polyesters of making the polyesters useful in the invention may be prepared using at least one tin compound and at least one catalyst chosen from titanium compound as catalysts.

In one embodiment, the addition of the phosphorus compound(s) in process(es) of making the aliphatic-aromatic polyesters useful in the invention and/or the aliphatic polyesters useful in the invention can result in a weight ratio of total tin atoms to total phosphorus atoms in the final polyester of 2-10:1. In one embodiment, the addition of the phosphorus compound(s) in the process(es) of making the aliphatic-aromatic polyesters useful in the invention and/or the aliphatic polyesters useful in the invention can result in a weight ratio of total tin atoms to total phosphorus atoms in the final polyester of 5-9:1. In one embodiment, the addition of the phosphorus compound(s) in the process(es) of making the aliphatic-aromatic polyesters useful in the invention and/or the aliphatic polyesters useful in the invention can result in a weight ratio of total tin atoms to total phosphorus atoms in the final polyester of 6-8:1. In one embodiment, the addition of the phosphorus compound(s) in the process(es) of making the aliphatic-aromatic polyesters useful in the invention and/or the aliphatic polyesters useful in the invention can result in a weight ratio of total tin atoms to total phosphorus atoms in the final polyester of 7:1. For example, the weight of tin atoms and phosphorus atoms present in the final aliphatic-aromatic polyester useful in the invention and/or the aliphatic polyester useful in the invention can be measured in ppm and can result in a weight ratio of total tin atoms to total phosphorus atoms in the final polyester of any of the aforesaid weight ratios.

In one aspect, the polyester blends of the invention are useful in articles of manufacture including, but not limited to, extruded, calendered, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, sheet and/or fibers.

In one aspect, the polyester blends of the invention may be used in various types of film and/or sheet, including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting.

### DETAILED DESCRIPTION

Unless otherwise indicated, all numbers expressing quantities of ingredients, properties such as molecular weight, reaction conditions, and so forth used in the specification and claims are to be understood as being modified in all instances by the term “about.” Unless indicated to the contrary, the numerical parameters set forth in the following specification and attached claims are approximations that may vary depending upon the desired properties sought to be obtained by the present invention. At the very least, each numerical parameter should be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

It is believed that polymer blends of the invention can have a unique combination of two or more physical properties such as moderate or high impact strengths, high glass transition temperatures, chemical resistance, toughness, low ductile-to-brittle transition temperatures, good color and clarity, low densities, and long crystallization half-times. In some of the embodiments of the invention, the polymer blends have a unique combination of the properties of good impact strength, heat resistance, clarity, density and/or the combination of the properties of good impact strength, heat resistance, and clarity and/or the combination of two or more of the described properties, that have never before been believed to be present in this type of polymer blend.

In one embodiment, the processes of making the polyesters useful in the blends of the invention can comprise a batch or continuous process.

In one embodiment, the processes of making the polyesters useful in the blends of the invention comprise a continuous process.

### Aliphatic-Aromatic Polyesters and/or Aliphatic Polyesters

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. Alternatively, in the case of AAPE polyesters, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. Alternatively, in the case of aliphatic polyesters, the difunctional carboxylic acid may be a hydroxy carboxylic acid such as, for example, p-hydroxybenzoic acid, and the difunctional hydroxyl compound may be an aliphatic nucleus bearing 2 hydroxyl substituents such as, for example, 1,3-cyclohexanediol or 1,4-cyclohexanediol. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The APPE polyesters and/or the aliphatic polyesters useful in the present invention typically can be prepared from dicarboxylic acids and diols which react in substantially equal proportions and are incorporated into the polyester polymer as their corresponding residues. The APPE polyesters and/or the aliphatic polyesters useful in the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

In addition to the diols set forth above, the AAPE polyesters and/or the aliphatic polyesters useful in the polyester blends of the invention may be made from 1,3-propanediol, 1,4-butanediol, and mixtures thereof. It is contemplated that compositions of the invention made from 1,3-propanediol, 1,4-butanediol, and mixtures thereof can possess at least one of the Tg ranges described herein, at least one of the inherent viscosity ranges described herein, and/or at least one of the glycol or diacid ranges described herein.

For embodiments of the invention, the AAPE polyesters and/or the aliphatic polyesters useful in the polymer blends of the invention may exhibit at least one of the following inherent viscosities as determined in 60/40 (wt/wt) phenol/tetrachloroethane at a concentration of 0.25 g/50 ml at 25° C.: 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; 0.42 to 1.2 dL/g; 0.42 to 1.1 dL/g; 0.42 to 1 dL/g; 0.42 to less than 1 dL/g; 0.42 to 0.98 dL/g; 0.42 to 0.95 dL/g; 0.42 to 0.90 dL/g; 0.42 to 0.85 dL/g; 0.42 to 0.80 dL/g; 0.42 to 0.75 dL/g; 0.42 to less than 0.75 dL/g; 0.42 to 0.72 dL/g; 0.42 to 0.70 dL/g; 0.42 to less than 0.70 dL/g; 0.42 to 0.68 dL/g; 0.42 to less than 0.68 dL/g; and 0.42 to 0.65 dL/g.

For embodiments of the invention, the AAPE polyesters and/or the aliphatic polyesters useful in the polymer blends of the invention may exhibit at least one of the following inherent viscosities as determined in 60/40 (wt/wt) phenol/tetrachloroethane at a concentration of 0.25 g/50 ml at 25° C.: 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.67 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.60 to 0.64 dL/g; 0.61 to 0.68 dL/g; 0.64 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g; 0.68 to 1.2 dL/g; 0.68 to 1.1 dL/g; 0.68 to 1 dL/g; 0.68 to less than 1 dL/g; 0.68 to 0.98 dL/g; 0.68 to 0.95 dL/g; 0.68 to 0.90 dL/g; 0.68 to 0.85 dL/g; 0.68 to 0.80 dL/g; 0.68 to 0.75 dL/g; 0.68 to less than 0.75 dL/g; 0.68 to 0.72 dL/g; 0.69 to 0.75 dL/g; 0.76 dL/g to 1.2 dL/g; 0.76 dL/g to 1.1 dL/g; 0.76 dL/g to 1 dL/g; 0.76 dL/g to less than 1 dL/g; 0.76 dL/g to 0.98dL/g; 0.76 dL/g to 0.95 dL/g; 0.76 dL/g to 0.90 dL/g 0.80 dL/g to 1.2 dL/g; 0.80 dL/g to 1.1 dL/g; 0.80 dL/g to 1 dL/g; 0.80 dL/g to less than 1 dL/g; 0.80 dL/g to 1.2 dL/g; 0.80 dL/g to 0.98dL/g; 0.80 dL/g to 0.95 dL/g; 0.80 dL/g to 0.90 dL/g.

It is contemplated that APPE polyesters and/or the aliphatic polyesters useful in the invention can possess at least one of the inherent viscosity ranges described herein and at least one of the monomer ranges for the compositions described herein unless otherwise stated. It is also contemplated that APPE polyesters and/or the aliphatic polyesters useful in the invention can possess at least one of the Tg ranges described herein and at least one of the monomer ranges for the APPE polyesters and/or the aliphatic polyesters described herein unless otherwise stated. It is also contemplated that APPE polyesters and/or the aliphatic polyesters useful in the invention can possess at least one of the inherent viscosity ranges described herein, at least one of the Tg ranges described herein, and at least one of the monomer ranges for the compositions described herein unless otherwise stated.

In one embodiment, terephthalic acid may be used as a starting material. In another embodiment, dimethyl terephthalate may be used as a starting material. In yet another embodiment, mixtures of terephthalic acid and dimethyl terephthalate may be used as a starting material and/or as an intermediate material.

For the desired AAPE polyester and/or the aliphatic polyester, the molar ratio of cis/trans 2,2,4,4-tetramethyl-1,3-cyclobutanediol can vary from the pure form of each and mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30 mole % trans; or 40 to 60 mole % cis and 60 to 40 mole % trans; or 50 to 70 mole % trans and 50 to 30 mole % cis; or 50 to 70 mole % cis and 50 to 30 mole % trans; or 60 to 70 mole % cis and 30 to 40 mole % trans; or greater than 70 mole % cis and less than 30 mole % trans; wherein the total mole percentages for cis- and trans-2,2,4,4-tetramethyl-1,3-cyclobutanediol is equal to 100 mole %. In an additional embodiment, the molar ratio of cis/trans 2,2,4,4-tetramethyl-1,3-cyclobutanediol can vary within the range of 50/50 to 0/100, for example, between 40/60 to 20/80.

The cyclohexanedimethanol may be cis, trans, or a mixture thereof, for example, a cis/trans ratio of 60:40 to 40:60 or a cis/trans ratio of 70:30 to 30:70. In another embodiment, the trans-cyclohexanedimethanol can be present in an amount of 60 to 80 mole % and the cis-cyclohexanedimethanol can be present in an amount of 20 to 40 mole % wherein the total percentages of cis-cyclohexanedimethanol and trans-cyclohexanedimethanol is equal to 100 mole %. In particular embodiments, the trans-cyclohexanedimethanol can be present in an amount of 60 mole % and the cis-cyclohexanedimethanol can be present in an amount of 40 mole %. In particular embodiments, the trans-cyclohexanedimethanol can be present in an amount of 70 mole % and the cis-cyclohexanedimethanol can be present in an amount of 30 mole %. Any of 1,1-, 1,2-, 1,3-, 1,4-isomers of cyclohexanedimethanol or mixtures thereof may be present in the glycol component of this invention. In one embodiment, the AAPE polyesters and/or aliphatic useful in the invention comprise 1,4-cyclohexanedimethanol. In another embodiment, the AAPE polyesters and/or aliphatic polyesters useful in the invention comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

Modifying glycols useful in the AAPE polyesters and/or aliphatic polyesters useful in the polymer blends of the invention refer to diols other than 2,2,4,4-tetramethyl-1,3-cyclobutanediol and cyclohexanedimethanol and can contain 2 to 16 carbon atoms. Examples of suitable modifying glycols include, but are not limited to, ethylene glycol residues, 1,2-propanediol, 1,3-propanediol, neopentyl glycol, 1,4-butanediol, 1,5-pentanediol, 1,6-hexanediol, p-xylene glycol, polytetramethylene glycol, polyethylene glycol, and/or mixtures thereof. In one embodiment, the modifying glycol is ethylene glycol. In another embodiment, the modifying glycols include, but are not limited to, at least one of 1,3-propanediol and 1,4-butanediol. In another embodiment, ethylene glycol residues is excluded as a modifying diol. In another embodiment, 1,3-propanediol and 1,4-butanediol are excluded as modifying diols. In another embodiment, 2, 2-dimethyl-1,3-propanediol is excluded as a modifying diol.

The AAPE polyesters and/or aliphatic polyesters useful in the polymer blends of the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the AAPE polyester and/or aliphatic polyester. The AAPE polyester(s) and/or aliphatic polyester useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The AAPE polyesters and/or aliphatic polyesters useful in the polymer blends of the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

The glass transition temperature (Tg) of the AAPE polyesters and/or aliphatic polyesters useful in the polymer blends of the invention was determined using a TA DSC 2920 from Thermal Analyst Instrument at a scan rate of 20° C./min.

In one embodiment, certain AAPE polyesters as well as the polymer blends useful in this invention can be visually clear. The term “visually clear” is defined herein as an appreciable absence of cloudiness, haziness, and/or muddiness, when inspected visually. In another embodiment, when the polyesters are blended with polycarbonate, including but not limited to, bisphenol A polycarbonates, the blends can be visually clear.

Notched Izod impact strength, as described in ASTM D256, is a common method of measuring toughness.

When tin is added to the polyesters useful in the blends of the invention, it is added to the process of making the polyester in the form of a tin compound. The amount of the tin compound added to the polyesters useful in the blends of the invention can be measured in the form of tin atoms present in the final polyester blend, for example, by weight measured in ppm.

When phosphorus is added to the polyesters useful in the blends of the invention, it is added to the process of making the polyester in the form of a phosphorus compound. In one embodiment, this phosphorus compound can comprise at least one phosphate ester(s). The amount of phosphorus compound, [for example, phosphate ester(s)] added to the polyesters useful in the blends of the invention can be measured in the form of phosphorus atoms present in the final polyester blend, for example, by weight measured in ppm.

When titanium is added to the polyesters useful in the blends of the invention, it is added to the process of making the polyester in the form of a titanium compound, for example, titanium alkoxides, and/or titanium/silicon dioxides. The amount of titanium compound added to the polyesters useful in the blends of the invention can be measured in the form of titanium atoms present in the final polyester blend, for example, by weight measured in ppm.

In one aspect, the phosphorus compounds useful in AAPE polyesters and/or the aliphatic polyesters useful in the polymer blends of the invention comprise phosphoric acid, phosphorous acid, phosphonic acid, phosphinic acid, phosphonous acid, and various esters and salts thereof. The esters can be alkyl, branched alkyl, substituted alkyl, difunctional alkyl, alkyl ethers, aryl, and substituted aryl.

In one aspect, the phosphorus compounds useful in AAPE polyesters and/or the aliphatic polyesters useful in the polymer blends of the invention can be chosen from at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed alkyl aryl phosphites, reaction products thereof, and mixtures thereof. The phosphate esters include esters in which in which the phosphoric acid is fully esterified or only partially esterified.

In one embodiment, the phosphate esters useful in AAPE polyesters and/or the aliphatic polyesters useful in the polymer blends of the invention include but are not limited to dibutylphenyl phosphate, triphenyl phosphate, tricresyl phosphate, tributyl phosphate, tri-2-ethylhexyl phosphate, trioctyl phosphate, and/or mixtures thereof, including particularly mixtures of tributyl phosphate and tricresyl phosphate, and mixtures of isocetyl diphenyl phosphate and 2-ethylhexyl diphenyl phosphate.

In one embodiment, the phosphate esters useful in AAPE polyesters and/or the aliphatic polyesters useful in the polymer blends of the invention include but are not limited to, at least one of the following: trialkyl phosphates, triaryl phosphates, alkyl diaryl phosphates, and mixed alkyl aryl phosphates.

In one embodiment, the phosphate esters useful in AAPE polyesters and/or the aliphatic polyesters useful in the polymer blends of the invention include but are not limited to, at least one of the following: triaryl phosphates, alkyl diaryl phosphates, and mixed alkyl aryl phosphates.

In one embodiment, the phosphate esters useful in AAPE polyesters and/or the aliphatic polyesters useful in the polymer blends of the invention include but are not limited to, at least one of the following: triaryl phosphates and mixed alkyl aryl phosphates.

In one embodiment, at least one phosphorus compound useful in AAPE polyesters and/or the aliphatic polyesters useful in the polymer blends of the invention comprises, but is not limited to, triaryl phosphates, such as, for example, triphenyl phosphate. In one embodiment, at least one one phosphorus compound comprises, but is not limited to Merpol A. In one embodiment, at least one phosphorus compound useful in the invention comprises, but is not limited to, at least one of triphenyl phosphate and Merpol A. Merpol A is a phosphate ester commercially available from Stepan Chemical Co and/or E.I. duPont de Nemours & Co. The CAS Registry number for Merpol A is believed to be CAS Registry #37208-27-8.

When phosphorus is added to the polyesters and/or polyester blends and/or process of making the polyesters useful in the invention, it is added in the form of a phosphorus compound, for example, at least one phosphate ester(s). The amount of phosphorus compound(s), (for example, at least one phosphate ester), is added to the AAPE polyesters and/or aliphatic polyesters useful in the invention and/or polyester blends of the invention and/or processes of the invention can be measured in the form of phosphorus atoms present in the final polyester, for example, by weight measured in ppm.

In one embodiment, the polymer blends of the invention can comprise 5 to 90 weight % of said at least one aliphatic-aromatic polyester and 10 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 85 weight % of said at least one aliphatic-aromatic polyester and 15 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 75 weight % of said at least one aliphatic-aromatic polyester and 25 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 70 weight % of said at least one aliphatic-aromatic polyester and 30 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 65 weight % of said at least one aliphatic-aromatic polyester and 35 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 55 weight % of said at least one aliphatic-aromatic polyester and 45 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 50 weight % of said at least one aliphatic-aromatic polyester and 50 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 45 weight % of said at least one aliphatic-aromatic polyester and 55 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 40 weight % of said at least one aliphatic-aromatic polyester and 60 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 35 weight % of said at least one aliphatic-aromatic polyester and 65 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 30 weight % of said at least one aliphatic-aromatic polyester and 70 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 25 weight % of said at least one aliphatic-aromatic polyester and 75 to 95 weight % of said at least one aliphatic polyester, wherein the total weight % of the aliphatic-aromatic polyester and the aliphatic polyester equals 100 weight %.

In one embodiment, the polymer blends of the invention can comprise 10 to 90 weight % of said at least one aliphatic-aromatic polyester and 10 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 85 weight % of said at least one aliphatic-aromatic polyester and 15 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 75 weight % of said at least one aliphatic-aromatic polyester and 25 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 70 weight % of said at least one aliphatic-aromatic polyester and 30 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 65 weight % of said at least one aliphatic-aromatic polyester and 35 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 55 weight % of said at least one aliphatic-aromatic polyester and 45 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 50 weight % of said at least one aliphatic-aromatic polyester and 50 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 45 weight % of said at least one aliphatic-aromatic polyester and 55 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 40 weight % of said at least one aliphatic-aromatic polyester and 60 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 35 weight % of said at least one aliphatic-aromatic polyester and 65 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 30 weight % of said at least one aliphatic-aromatic polyester and 70 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 25 weight % of said at least one aliphatic-aromatic polyester and 75 to 90 weight % of said at least one aliphatic polyester, wherein the total weight % of the aliphatic-aromatic polyester and the aliphatic polyester equals 100 weight %.

In one embodiment, the polymer blends of the invention can comprise 15 to 90 weight % of said at least one aliphatic-aromatic polyester and 10 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 85 weight % of said at least one aliphatic-aromatic polyester and 15 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 75 weight % of said at least one aliphatic-aromatic polyester and 25 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 70 weight % of said at least one aliphatic-aromatic polyester and 30 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 65 weight % of said at least one aliphatic-aromatic polyester and 35 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 55 weight % of said at least one aliphatic-aromatic polyester and 45 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 50 weight % of said at least one aliphatic-aromatic polyester and 50 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 45 weight % of said at least one aliphatic-aromatic polyester and 55 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 40 weight % of said at least one aliphatic-aromatic polyester and 60 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 35 weight % of said at least one aliphatic-aromatic polyester and 65 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 30 weight % of said at least one aliphatic-aromatic polyester and 70 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 25 weight % of said at least one aliphatic-aromatic polyester and 75 to 85 weight % of said at least one aliphatic polyester, wherein the total weight % of the aliphatic-aromatic polyester and the aliphatic polyester equals 100 weight %.

In one embodiment, the polymer blends of the invention can comprise 20 to 90 weight % of said at least one aliphatic-aromatic polyester and 10 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 85 weight % of said at least one aliphatic-aromatic polyester and 15 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 75 weight % of said at least one aliphatic-aromatic polyester and 25 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 70 weight % of said at least one aliphatic-aromatic polyester and 30 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 65 weight % of said at least one aliphatic-aromatic polyester and 35 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 55 weight % of said at least one aliphatic-aromatic polyester and 45 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 50 weight % of said at least one aliphatic-aromatic polyester and 50 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 45 weight % of said at least one aliphatic-aromatic polyester and 55 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 40 weight % of said at least one aliphatic-aromatic polyester and 60 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 35 weight % of said at least one aliphatic-aromatic polyester and 65 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 30 weight % of said at least one aliphatic-aromatic polyester and 70 to 80 weight % of said at least one aliphatic polyester, wherein the total weight % of the aliphatic-aromatic polyester and the aliphatic polyester equals 100 weight %.

In one embodiment, the polymer blends of the invention can comprise 30 to 90 weight % of said at least one aliphatic-aromatic polyester and 10 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 85 weight % of said at least one aliphatic-aromatic polyester and 15 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 75 weight % of said at least one aliphatic-aromatic polyester and 25 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 70 weight % of said at least one aliphatic-aromatic polyester and 30 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 65 weight % of said at least one aliphatic-aromatic polyester and 35 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 55 weight % of said at least one aliphatic-aromatic polyester and 45 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 50 weight % of said at least one aliphatic-aromatic polyester and 50 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 45 weight % of said at least one aliphatic-aromatic polyester and 55 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 40 weight % of said at least one aliphatic-aromatic polyester and 60 to 70 weight % of said at least one aliphatic polyester, wherein the total weight % of the aliphatic-aromatic polyester and the aliphatic polyester equals 100 weight %.

In one embodiment, the polymer blends of the invention can comprise 40 to 90 weight % of said at least one aliphatic-aromatic polyester and 10 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 85 weight % of said at least one aliphatic-aromatic polyester and 15 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 75 weight % of said at least one aliphatic-aromatic polyester and 25 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 70 weight % of said at least one aliphatic-aromatic polyester and 30 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 65 weight % of said at least one aliphatic-aromatic polyester and 35 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 55 weight % of said at least one aliphatic-aromatic polyester and 45 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 50 weight % of said at least one aliphatic-aromatic polyester and 50 to 60 weight % of said at least one aliphatic polyester, wherein the total weight % of the aliphatic-aromatic polyester and the aliphatic polyester equals 100 weight %.

In one embodiment, the polymer blends of the invention can comprise 50 to 90 weight % of said at least one aliphatic-aromatic polyester and 10 to 50 weight % of said at least one aliphatic polyester, wherein the total weight % of the aliphatic-aromatic polyester and the aliphatic polyester equals 100 weight %. In one embodiment, the polymer blends of the invention can comprise 50 to 85 weight % of said at least one aliphatic-aromatic polyester and 15 to 50 weight % of said at least one aliphatic polyester, wherein the total weight % of the aliphatic-aromatic polyester and the aliphatic polyester equals 100 weight %. In one embodiment, the polymer blends of the invention can comprise 50 to 75 weight % of said at least one aliphatic-aromatic polyester and 25 to 50 weight % of said at least one aliphatic polyester, wherein the total weight % of the aliphatic-aromatic polyester and the aliphatic polyester equals 100 weight %. In one embodiment, the polymer blends of the invention can comprise 20 to 50 weight % of said at least one aliphatic-aromatic polyester and 30 to 50 weight % of said at least one aliphatic polyester, wherein the total weight % of the aliphatic-aromatic polyester and the aliphatic polyester equals 100 weight %. In one embodiment, the polymer blends of the invention can comprise 50 to 65 weight % of said at least one aliphatic-aromatic polyester and 35 to 50 weight % of said at least one aliphatic polyester, wherein the total weight % of the aliphatic-aromatic polyester and the aliphatic polyester equals 100 weight %.

In one embodiment, the polymer blends of the invention can comprise 10 to 50 weight % of said at least one aliphatic-aromatic polyester and 50 to 90 weight % of said at least one aliphatic polyester, wherein the total weight % of the aliphatic-aromatic polyester and the aliphatic polyester equals 100 weight %. In one embodiment, the polymer blends of the invention can comprise 20 to 50 weight % of said at least one aliphatic-aromatic polyester and 50 to 80 weight % of said at least one aliphatic polyester, wherein the total weight % of the aliphatic-aromatic polyester and the aliphatic polyester equals 100 weight %.

The invention further relates to a polymer blend comprising polyesters other than the AAPE polyesters and aliphatic polyesters as described as useful previously in the polymer blends of the invention. The blend comprises:
(a) from 5 to 95 weight % of at least one of the AAPE polyesters described herein; and
(b) from 5 to 95 weight % of at least one of the aliphatic polyesters described herein;
(c) from 5 to 95 weight % of at least one additional polymeric components not including the polyesters of (a) and (b);
wherein the total weight percent of all polymeric components in the polymer blends of the invention equals a total of 100 weight %.

Suitable examples of the additional polymeric components include, but are not limited to, nylon; polyesters different than those described herein; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the foregoing polymers.

All polymer blends (also intended to encompass the word “mixtures”) of the invention can be prepared by conventional processing techniques known in the art, such as melt blending or solution blending. The compositions of this invention are prepared by any conventional mixing methods. For example, in one embodiment, the blending method comprises mixing the aliphatic-aromatic and aliphatic polyester in powder or granular form in an extruder and extruding the mixture into strands, chopping the strands into pellets and molding the pellets into the desired article.

In addition, the polyester blends of the invention may also contain from 0.01 to 25% by weight of the overall composition common additives such as colorants, dyes, mold release agents, flame retardants, plasticizers, nucleating agents, stabilizers, including but not limited to, UV stabilizers, thermal stabilizers and/or reaction products thereof, fillers, and impact modifiers. Examples of typical commercially available impact modifiers well known in the art and useful in this invention include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition

Reinforcing materials may be useful in the polymer blends of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

The polyester blends of the invention may also comprise at least one tin compound. When tin is added to the AAPE polyesters and/or aliphatic polyesters useful in the invention and/or process of making the polyesters useful in the invention, it is added to the process of making the polyester in the form of a tin compound. The amount of the tin compound added to the polyesters useful in the invention and/or processes of making the polyesters useful in the invention can be measured in the form of tin atoms present in the final AAPE polyester and/or final aliphatic polyester and/or the final polymer blend, for example, by weight measured in ppm.

The polyester portion of the polyester blends useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

In one embodiment, the addition of the phosphorus compound(s), for example, phosphate ester(s), in the process(es) of making the AAPE polyesters and/or aliphatic polyesters useful in the polymer blends of invention can result in a weight ratio of total tin atoms to total phosphorus atoms in the final polyester blend(s) useful in the invention of 2-10:1. In one embodiment, the addition of the phosphorus compound(s) in the process(es) of making the AAPE polyesters and/or aliphatic polyesters useful in the polymer blends of the invention can result in a weight ratio of total tin atoms to total phosphorus atoms in the final polyester blend(s) of 5-9:1. In one embodiment, the addition of the phosphorus compound(s) in the process(es) of making the AAPE polyesters and/or aliphatic polyesters useful in the polymer blends of the invention can result in a weight ratio of total tin atoms to total phosphorus atoms in the final polyester blend(s) of 6-8:1. In one embodiment, the addition of the phosphorus compound(s) in the process(es) of making polyesters of the invention, whether AAPE polyesters or aliphatic polyesters or both, can result in a weight ratio of total tin atoms to total phosphorus atoms in the final AAPE polyester and/or aliphatic polyesters and/or polyester blends of 7:1. For example, the weight of tin atoms and phosphorus atoms present in the final AAPE polyester and/or and/or aliphatic polyesters and/or polymer blends can be measured in ppm and can result in a weight ratio of total tin atoms to total phosphorus atoms in the final AAPE polyester and/or polyester blends, respectively, of any of the aforesaid weight ratios.

### Additional Aliphatic-Aromatic Polyester(s) Description

In other aspects of the invention, the Tg of certain aliphatic-aromatic (AAPE) polyesters useful in the polyester blends of the invention can be at least one of the following ranges: 60 to 200° C.; 60 to 190° C.; 60 to 180° C.; 60 to 170° C.; 60 to 160° C.; 60 to 155° C.; 60 to 150° C.; 60 to 145° C.; 60 to 140° C.; 60 to 138° C.; 60 to 135° C.; 60 to 130° C.; 60 to 125° C.; 60 to 120° C.; 60 to 115° C.; 60 to 110° C.; 60 to 105° C.; 60 to 100° C.; 60 to 95° C.; 60 to 90° C.; 60 to 85° C.; 60 to 80° C.; 60 to 75° C.; 65 to 200° C.; 65 to 190° C.; 65 to 180° C.; 65 to 160° C.; 65 to 155° C.; 65 to 150° C.; 65 to 145° C.; 65 to 140° C.; 65 to 138° C.; 65 to 135° C.; 65 to 130° C.; 65 to 125° C.; 65 to 120° C.; 65 to 115° C.; 65 to 110° C.; 65 to 105° C.; 65 to 100° C.; 65 to 95° C.; 65 to 90° C.; 65 to 85° C.; 65 to 80° C.; 65 to 75° C.; 70 to 200° C.; 70 to 190° C.; 70 to 180° C.; 70 to 170° C.; 70 to 160° C.; 70 to 155° C.; 70 to 150° C.; 70 to 145° C.; 70 to 140° C.; 70 to 138° C.; 70 to 135° C.; 70 to 130° C.; 70 to 125° C.; 70 to 120° C.; 70 to 115° C.; 70 to 110° C.; 70 to 105° C.; 70 to 100° C.; 70 to 95° C.; 70 to 90° C.; 70 to 85° C.; 70 to 80° C.; 70 to 75° C.; 75 to 200° C; 75 to 190° C.; 75 to 180° C.; 75 to 170° C.; 75 to 160° C.; 75 to 155° C.; 75 to 150° C.; 75 to 145° C.; 75 to 140° C.; 75 to 138° C.; 75 to 135° C.; 75 to 130° C.; 75 to 125° C.; 75 to 120° C.; 75 115° C.; 75 to 110° C.; 75 to 105° C.; 75 to 100° C.; 75 to 95° C.; 75 to 90° C.; 75 to 85° C.; 75 to 80° C.; 80 to 200° C.; 80 to 190° C.; 80 to 180° C.; 80 to 170° C.; 80 to 160° C.; 80 to 155° C.; 80 to 150° C.; 80 to 145° C.; 80 to 140° C.; 80 to 138° C.; 80 to 135° C.; 80 to 130° C.; 80 to 125° C.; 80 to 120° C.; 80 to 115° C.; 80 to 110° C.; 80 to 105° C.; 80 to 100° C.; 80 to 95° C.; 80 to 90° C.; 80 to 85° C.; 85 to 200° C.; 85 to 190° C.; 85 to 180° C.; 85 to 170° C.; 85 to 160° C.; 85 to 155° C.; 85 to 150° C.; 85 to 145° C.; 85 to 140° C.; 85 to 138° C.; 85 to 135° C.; 85 to 130° C.; 85 to 125° C.; 85 to 120° C.; 85 to 115° C.; 85 to 110° C.; 85 to 105° C.; 85 to 100° C.; 85 to 95° C.; 85 to 90° C.; 90 to 200° C.; 90 to 190° C.; 90 to 180° C.; 90 to 170° C.; 90 to 160° C.; 90 to 155° C.; 90 to 150° C.; 90 to 145° C.; 90 to 140° C.; 90 to 138° C.; 90 to 135° C.; 90 to 130° C.; 90 to 125° C.; 90 to 120° C.; 90 to 115° C.; 90 to 110° C.; 90 to 105° C.; 90 to 100° C.; 90 to 95° C.; 95 to 200° C.; 95 to 190° C.; 95 to 180° C.; 95 to 170° C.; 95 to 160° C.; 95 to 155° C.; 95 to 150° C.; 95 to 145° C.; 95 to 140° C.; 95 to 138° C.; 95 to 135° C.; 95 to 130° C.; 95 to 125° C.; 95 to 120° C.; 95 to 115° C.; 95 to 110° C.; 95 to 105° C.; 95 to 100° C.; 100 to 200° C.; 100 to 190° C.; 100 to 180° C.; 100 to 170° C.; 100 to 160° C.; 100 to 155° C.; 100 to 150° C.; 100 to 145° C.; 100 to 140° C.; 100 to 138° C.; 100 to 135° C.; 100 to 130° C.; 100 to 125° C.; 100 to 120° C.; 100 to 115° C.; 100 to 110° C.; 105 to 200° C.; 105 to 190° C.; 105 to 180° C.; 105 to 170° C.; 105 to 160° C.; 105 to 155° C.; 105 to 150° C.; 105 to 145° C.; 105 to 140° C.; 105 to 138° C.; 105 to 135° C.; 105 to 130° C.; 105 to 125° C.; 105 to 120° C.; 105 to 115° C.; 105 to 110° C.; 110 to 200° C.; 110 to 190° C.; 110 to 180°C.; 110 to 170° C.; 110 to 160° C.; 110 to 155° C.; 110 to 150° C.; 110 to 145° C.; 110 to 140° C.; 110 to 138° C.; 110 to 135° C.; 110 to 130° C.; 110 to 125° C.; 110 to 120° C.; 110 to 115° C.; 115 to 200° C.; 115 to 190° C.; 115 to 180° C.; 115 to 170° C.; 115 to 160° C.; 115 to 155° C.; 115 to 150° C.; 115 to 145° C.; 115 to 140° C.; 115 to 138° C.; 115 to 135° C.; 110 to 130° C.; 115 to 125° C.; 115 to 120° C.; 120 to 200° C.; 120 to 190° C.; 120 to 180° C.; 120 to 170° C.; 120 to 160° C.; 120 to 155° C.; 120 to 150° C.; 120 to 145° C.; 120 to 140° C.; 120 to 138° C.; 120 to 135° C.; 120 to 130° C.; 125 to 200° C.; 125 to 190° C.; 125 to 180° C.; 125 to 170° C.; 125 to 165° C.; 125 to 160° C.; 125 to 155° C.; 125 to 150° C.; 125 to 145° C.; 125 to 140° C.; 125 to 138° C.; 125 to 135° C.; 127 to 200° C.; 127 to 190° C.; 127to 180° C.; 127 to 170° C.; 127 to 160° C.; 127to 150° C.; 127 to 145° C.; 127 to 140° C.; 127 to 138° C.; 127 to 135° C.; 130 to 200° C.; 130 to 190° C.; 130 to 180° C.; 130 to 170° C.; 130 to 160° C.; 130 to 155° C.; 130 to 150° C.; 130 to 145° C.; 130 to 140° C.; 130 to 138° C.; 130 to 135° C.; 135 to 200° C.; 135 to 190° C.; 135 to 180° C.; 135 to 170° C.; 135 to 160° C.; 135 to 155° C.; 135 to 150° C.; 135 to 145° C.; 135 to 140° C.; 140 to 200° C.; 140 to 190° C.; 140 to 180° C.; 140 to 170° C.; 140 to 160° C.; 140 to 155° C.; 140 to 150° C.; 140 to 145° C.; 148 to 200° C.; 148 to 190° C.; 148 to 180° C.; 148 to 170° C.; 148 to 160° C.; 148 to 155° C.; 148 to 150° C.; greater than 148 to 200° C.; greater than 148 to 190° C.; greater than 148 to 180° C.; greater than 148 to 170° C.; greater than 148 to 160° C.; greater than 148 to 155° C.; 150 to 200° C.; 150 to 190° C.; 150 to 180° C.; 150 to 170° C.; 150 to 160; 155 to 190° C.; 155 to 180° C.; 155 to 170° C.; and 155 to 165° C.

In other aspects of the invention, the Tg of certain AAPE polyesters useful in the polyester compositions of the invention can be at least one of the following ranges: 90 to 120° C.; 95 to 120° C.; 100 to 120° C.; 105 to 120° C.; 110 to 120° C.; 90 to 115° C.; 95 to 115° C.; 100-115° C.; 105 to 115° C.; 90 to 110° C.; 95 to 110° C.; 100 to 110° C.; 90 to 100° C.; 90 to 105° C.; 95 to 105° C.; and 90 to 100° C.

In other aspects of the invention, the glycol component for the AAPE polyesters useful in blends of the invention include but are not limited to at least one of the following combinations of ranges: 5 to 99 mole % 2,2,4,4-tetramethyl-1,3-cyclobutanediol and 1 to 95 mole % cyclohexanedimethanol; 5 to 95 mole % 2,2,4,4-tetramethyl-1,3-cyclobutanediol and 5 to 95 mole % cyclohexanedimethanol; 5 to 90 mole % 2,2,4,4-tetramethyl-1,3-cyclobutanediol and 10 to 95 mole % cyclohexanedimethanol; 5 to 85 mole % 2,2,4,4-tetramethyl-1,3-cyclobutanediol and 15 to 95 mole % cyclohexanedimethanol; 5 to 80 mole % 2,2,4,4-tetramethyl-1,3-cyclobutanediol and 20 to 95 mole % cyclohexanedimethanol, 5 to 75 mole % 2,2,4,4-tetramethyl-1,3-cyclobutanediol and 25 to 95 mole % cyclohexanedimethanol; 5 to 70 mole % 2,2,4,4-tetramethyl-1,3-cyclobutanediol and 30 to 95 mole % cyclohexanedimethanol; 5 to 65 mole % 2,2,4,4-tetramethyl-1,3-cyclobutanediol and 35 to 95 mole % cyclohexanedimethanol; 5 to 60 mole % 2,2,4,4-tetramethyl-1,3-cyclobutanediol and 40 to 95 mole % cyclohexanedimethanol; 5 to 55 mole % 2,2,4,4-tetramethyl-1,3-cyclobutanediol and 45 to 95 mole % cyclohexanedimethanol; and 5 to 50 mole % 2,2,4,4-tetramethyl-1,3-cyclobutanediol and 50 to 95 mole % cyclohexanedimethanol.

In other aspects of the invention, the glycol component for the AAPE polyesters useful in the polymer blends of the invention include but are not limited to at least one of the following combinations of ranges: 5 to less than 50 mole % 2,2,4,4-tetramethyl-1,3-cyclobutanediol and greater than 50 to 95 mole % cyclohexanedimethanol; 5 to 45 mole % 2,2,4,4-tetramethyl-1,3-cyclobutanediol and 55 to 95 mole % cyclohexanedimethanol; 5 to 40 mole % 2,2,4,4-tetramethyl-1,3-cyclobutanediol and 60 to 95 mole % cyclohexanedimethanol; 5 to 35 mole % 2,2,4,4-tetramethyl-1,3-cyclobutanediol and 65 to 95 mole % cyclohexanedimethanol; 5 to less than 35 mole % 2,2,4,4-tetramethyl-1,3-cyclobutanediol and greater than 65 to 95 mole % cyclohexanedimethanol; 5 to 30 mole % 2,2,4,4-tetramethyl-1,3-cyclobutanediol and 70 to 95 mole % cyclohexanedimethanol; 5 to 25 mole % 2,2,4,4-tetramethyl-1,3-cyclobutanediol and 75 to 95 mole % cyclohexanedimethanol; 5 to 20 mole % 2,2,4,4-tetramethyl-1,3-cyclobutanediol and 80 to 95 mole % cyclohexanedimethanol; 5 to 15 mole % 2,2,4,4-tetramethyl-1,3-cyclobutanediol and 85 to 95 mole % cyclohexanedimethanol; 5 to 10 mole % 2,2,4,4-tetramethyl-1,3-cyclobutanediol and 90 to 95 mole % cyclohexanedimethanol; greater than 5 to less than 10 mole % 2,2,4,4-tetramethyl-1,3-cyclobutanediol and less than 90 to greater than 95 mole % cyclohexanedimethanol; 5.5 mole % to 9.5 mole % 2,2,4,4-tetramethyl-1,3-cyclobutanediol and 94.5 mole % to 90.5 mole % cyclohexanedimethanol; and 6 to 9 mole % 2,2,4,4-tetramethyl-1,3-cyclobutanediol and 94 to 91 mole % cyclohexanedimethanol.

In other aspects of the invention, the glycol component for the AAPE polyesters useful in the polymer blends of the invention include but are not limited to at least one of the following combinations of ranges: 10 to 99 mole % 2,2,4,4-tetramethyl-1,3-cyclobutanediol and 1 to 90 mole % cyclohexanedimethanol; 10 to 95 mole % 2,2,4,4-tetramethyl-1,3-cyclobutanediol and 5 to 90 mole % cyclohexanedimethanol; 10 to 90 mole % 2,2,4,4-tetramethyl-1,3-cyclobutanediol and 10 to 90 mole % cyclohexanedimethanol; 10 to 85 mole % 2,2,4,4-tetramethyl-1,3-cyclobutanediol and 15 to 90 mole % cyclohexanedimethanol; 10 to 80 mole % 2,2,4,4-tetramethyl-1,3-cyclobutanediol and 20 to 90 mole % cyclohexanedimethanol; 10 to 75 mole % 2,2,4,4-tetramethyl-1,3-cyclobutanediol and 25 to 90 mole % cyclohexanedimethanol; 10 to 70 mole % 2,2,4,4-tetramethyl-1,3-cyclobutanediol and 30 to 90 mole % cyclohexanedimethanol; 10 to 65 mole % 2,2,4,4-tetramethyl-1,3-cyclobutanediol and 35 to 90 mole % cyclohexanedimethanol; 10 to 60 mole % 2,2,4,4-tetramethyl-1,3-cyclobutanediol and 40 to 90 mole % cyclohexanedimethanol; 10 to 55 mole % 2,2,4,4-tetramethyl-1,3-cyclobutanediol and 45 to 90 mole % cyclohexanedimethanol; 10 to 50 mole % 2,2,4,4-tetramethyl-1,3-cyclobutanediol and 50 to 90 mole % cyclohexanedimethanol; 10 to less than 50 mole % 2,2,4,4-tetramethyl-1,3-cyclobutanediol and greater than 50 to 90 mole % cyclohexanedimethanol; 10 to 45 mole % 2,2,4,4-tetramethyl-1,3-cyclobutanediol and 55 to 90 mole % cyclohexanedimethanol; 10 to 40 mole % 2,2,4,4-tetramethyl-1,3-cyclobutanediol and 60 to 90 mole % cyclohexanedimethanol; 10 to 35 mole % 2,2,4,4-tetramethyl-1,3-cyclobutanediol and 65 to 90 mole % cyclohexanedimethanol; 10 to less than 35 mole % 2,2,4,4-tetramethyl-1,3-cyclobutanediol and greater than 65 to 90% cyclohexanedimethanol; 10 to 30 mole % 2,2,4,4-tetramethyl-1,3-cyclobutanediol and 70 to 90 mole % cyclohexanedimethanol; 10 to 25 mole % 2,2,4,4-tetramethyl-1,3-cyclobutanediol and 75 to 90 mole % cyclohexanedimethanol; 10 to 20 mole % 2,2,4,4-tetramethyl-1,3-cyclobutanediol and 80 to 90 mole % cyclohexanedimethanol; and 10 to 15 mole % 2,2,4,4-tetramethyl-1,3-cyclobutanediol and 85 to 90 mole % cyclohexanedimethanol.

In other aspects of the invention, the glycol component for the AAPE polyesters useful in the polymer blends of the invention include but are not limited to at least one of the following combinations of ranges: 10 to 100 mole % 2,2,4,4-tetramethyl-1,3-cyclobutanediol and 0 to 90 mole % cyclohexanedimethanol; greater than 10 to 99 mole % 2,2,4,4-tetramethyl-1,3-cyclobutanediol and 1 to less than 90 mole % cyclohexanedimethanol; greater than 10 to 95 mole % 2,2,4,4-tetramethyl-1,3-cyclobutanediol and 5 to less than 90 mole % cyclohexanedimethanol; greater than 10 to 90 mole % 2,2,4,4-tetramethyl-1,3-cyclobutanediol and 10 to less than 90 mole % cyclohexanedimethanol; greater than 10 to 85 mole % 2,2,4,4-tetramethyl-1,3-cyclobutanediol and 15 to less than 90 mole % cyclohexanedimethanol; greater than 10 to 80 mole % 2,2,4,4-tetramethyl-1,3-cyclobutanediol and 20 to less than 90 mole % cyclohexanedimethanol; greater than 10 to 75 mole % 2,2,4,4-tetramethyl-1,3-cyclobutanediol and 25 to less than 90 mole % cyclohexanedimethanol; greater than 10 to 70 mole % 2,2,4,4-tetramethyl-1,3-cyclobutanediol and 30 to less than 90 mole % cyclohexanedimethanol; greater than 10 to 65 mole % 2,2,4,4-tetramethyl-1,3-cyclobutanediol and 35 to less than 90 mole % cyclohexanedimethanol; greater than 10 to 60 mole % 2,2,4,4-tetramethyl-1,3-cyclobutanediol and 40 to less than 90 mole % cyclohexanedimethanol; greater than 10 to 55 mole % 2,2,4,4-tetramethyl-1,3-cyclobutanediol and 45 to less than 90 mole % cyclohexanedimethanol; greater than 10 to 50 mole % 2,2,4,4-tetramethyl-1,3-cyclobutanediol and 50 to less than 90 mole % cyclohexanedimethanol; greater than 10 to less than 50 mole % 2,2,4,4-tetramethyl-1,3-cyclobutanediol and greater than 50 to less than 90 mole % cyclohexanedimethanol; greater than 10 to 45 mole % 2,2,4,4-tetramethyl-1,3-cyclobutanediol and 55 to less than 90 mole % cyclohexanedimethanol; greater than 10 to 40 mole % 2,2,4,4-tetramethyl-1,3-cyclobutanediol and 60 to less than 90 mole % cyclohexanedimethanol; greater than 10 to 35 mole % 2,2,4,4-tetramethyl-1,3-cyclobutanediol and 65 to less than 90 mole % cyclohexanedimethanol; 10 to less than 34 mole % 2,2,4,4-tetramethyl-1,3-cyclobutanediol and greater than 66 to 90% cyclohexanedimethanol; greater than 10 to 30 mole % 2,2,4,4-tetramethyl-1,3-cyclobutanediol and 70 to less than 90 mole % cyclohexanedimethanol; greater than 10 to 25 mole % 2,2,4,4-tetramethyl-1,3-cyclobutanediol and 75 to less than 90 mole % cyclohexanedimethanol; greater than 10 to 20 mole % 2,2,4,4-tetramethyl-1,3-cyclobutanediol and 80 to less than 90 mole % cyclohexanedimethanol; and greater than 10 to 15 mole % 2,2,4,4-tetramethyl-1,3-cyclobutanediol and 85 to less than 90 mole % cyclohexanedimethanol.

In other aspects of the invention, the glycol component for the AAPE polyesters useful in the polymer blends of the invention include but are not limited to at least one of the following combinations of ranges: 15 to 99 mole % 2,2,4,4-tetramethyl-1,3-cyclobutanediol and 1 to 85 mole % cyclohexanedimethanol; 15 to 95 mole % 2,2,4,4-tetramethyl-1,3-cyclobutanediol and 5 to 85 mole % cyclohexanedimethanol; 15 to 90 mole % 2,2,4,4-tetramethyl-1,3-cyclobutanediol and 10 to 85 mole % cyclohexanedimethanol; 15 to 85 mole % 2,2,4,4-tetramethyl-1,3-cyclobutanediol and 15 to 85 mole % cyclohexanedimethanol; 15 to 80 mole % 2,2,4,4-tetramethyl-1,3-cyclobutanediol and 20 to 85 mole % cyclohexanedimethanol; 15 to 75 mole % 2,2,4,4-tetramethyl-1,3-cyclobutanediol and 25 to 85 mole % cyclohexanedimethanol; 15 to 70 mole % 2,2,4,4-tetramethyl-1,3-cyclobutanediol and 30 to 85 mole % cyclohexanedimethanol; 15 to 65 mole % 2,2,4,4-tetramethyl-1,3-cyclobutanediol and 35 to 85 mole % cyclohexanedimethanol; 15 to 60 mole % 2,2,4,4-tetramethyl-1,3-cyclobutanediol and 40 to 85 mole % cyclohexanedimethanol; 15 to 55 mole % 2,2,4,4-tetramethyl-1,3-cyclobutanediol and 45 to 85 mole % cyclohexanedimethanol; 15 to 50 mole % 2,2,4,4-tetramethyl-1,3-cyclobutanediol and 50 to 85 mole % cyclohexanedimethanol; 15 to less than 50 mole % 2,2,4,4-tetramethyl-1,3-cyclobutanediol and greater than 50 to 85 mole % cyclohexanedimethanol; 15 to 45 mole % 2,2,4,4-tetramethyl-1,3-cyclobutanediol and 55 to 85 mole % cyclohexanedimethanol; 15 to 40 mole % 2,2,4,4-tetramethyl-1,3-cyclobutanediol and 60 to 85 mole % cyclohexanedimethanol; 15 to 35 mole % 2,2,4,4-tetramethyl-1,3-cyclobutanediol and 65 to 85 mole % cyclohexanedimethanol; 15 to 30 mole % 2,2,4,4-tetramethyl-1,3-cyclobutanediol and 70 to 85 mole % cyclohexanedimethanol; 15 to 25 mole % 2,2,4,4-tetramethyl-1,3-cyclobutanediol and 75 to 85 mole % cyclohexanedimethanol; and 15 to 24 mole % 2,2,4,4-tetramethyl-1,3-cyclobutanediol and 76 to 85 mole % cyclohexanedimethanol.

In other aspects of the invention, the glycol component for the AAPE polyesters useful in the polymer blends of the invention include but are not limited to at least one of the following combinations of ranges: 20 to 99 mole % 2,2,4,4-tetramethyl-1,3-cyclobutanediol and 1 to 80 mole % cyclohexanedimethanol; 20 to 95 mole % 2,2,4,4-tetramethyl-1,3-cyclobutanediol and 5 to 80 mole % cyclohexanedimethanol; 20 to 90 mole % 2,2,4,4-tetramethyl-1,3-cyclobutanediol and 10 to 80 mole % cyclohexanedimethanol; 20 to 85 mole % 2,2,4,4-tetramethyl-1,3-cyclobutanediol and 15 to 80 mole % cyclohexanedimethanol; 20 to 80 mole % 2,2,4,4-tetramethyl-1,3-cyclobutanediol and 20 to 80 mole % cyclohexanedimethanol; 20 to 75 mole % 2,2,4,4-tetramethyl-1,3-cyclobutanediol and 25 to 80 mole % cyclohexanedimethanol; 20 to 70 mole % 2,2,4,4-tetramethyl-1,3-cyclobutanediol and 30 to 80 mole % cyclohexanedimethanol; 20 to 65 mole % 2,2,4,4-tetramethyl-1,3-cyclobutanediol and 35 to 80 mole % cyclohexanedimethanol; 20 to 60 mole % 2,2,4,4-tetramethyl-1,3-cyclobutanediol and 40 to 80 mole % 4cyclohexanedimethanol; 20 to 55 mole % 2,2,4,4-tetramethyl-1,3-cyclobutanediol and 45 to 80 mole % cyclohexanedimethanol; 20 to 50 mole % 2,2,4,4-tetramethyl-1,3-cyclobutanediol and 50 to 80 mole % cyclohexanedimethanol; 20 to less than 50 mole % 2,2,4,4-tetramethyl-1,3-cyclobutanediol and greater than 50 to 80 mole % cyclohexanedimethanol; 20 to 45 mole % 2,2,4,4-tetramethyl-1,3-cyclobutanediol and 55 to 80 mole % cyclohexanedimethanol; 20 to 40 mole % 2,2,4,4-tetramethyl-1,3-cyclobutanediol and 60 to 80 mole % cyclohexanedimethanol; 20 to 35 mole % 2,2,4,4-tetramethyl-1,3-cyclobutanediol and 65 to 80 mole % cyclohexanedimethanol; 20 to 30 mole % 2,2,4,4-tetramethyl-1,3-cyclobutanediol and 70 to 80 mole % cyclohexanedimethanol; and 20 to 25 mole % 2,2,4,4-tetramethyl-1,3-cyclobutanediol and 75 to 80 mole % cyclohexanedimethanol.

In other aspects of the invention, the glycol component for the AAPE polyesters useful in the polymer blends of the invention can include but are not limited to at least one of the following: 21 to 35 mole % 2,2,4,4-tetramethyl-1,3-cyclobutanediol and to 65 to 79 mole % cyclohexanedimethanol; 21 to 30 mole % 2,2,4,4-tetramethyl-1,3-cyclobutanediol and to 70 to 79 mole % cyclohexanedimethanol; and 21 to 25 mole % 2,2,4,4-tetramethyl-1,3-cyclobutanediol and 75 to 79 mole % cyclohexanedimethanol.

In other aspects of the invention, the glycol component for the AAPE polyesters useful in the polymer blends of the invention include but are not limited to at least one of the following combinations of ranges: 25 to 99 mole % 2,2,4,4-tetramethyl-1,3-cyclobutanediol and 1 to 75 mole % cyclohexanedimethanol; 25 to 95 mole % 2,2,4,4-tetramethyl-1,3-cyclobutanediol and 5 to 75 mole % cyclohexanedimethanol; 25 to 90 mole % 2,2,4,4-tetramethyl-1,3-cyclobutanediol and 10 to 75 mole % cyclohexanedimethanol; 25 to 85 mole % 2,2,4,4-tetramethyl-1,3-cyclobutanediol and 15 to 75 mole % cyclohexanedimethanol; 25 to 80 mole % 2,2,4,4-tetramethyl-1,3-cyclobutanediol and 20 to 75 mole % cyclohexanedimethanol; 25 to 75 mole % 2,2,4,4-tetramethyl-1,3-cyclobutanediol and 25 to 75 mole % cyclohexanedimethanol; 25 to 70 mole % 2,2,4,4-tetramethyl-1,3-cyclobutanediol and 30 to 75 mole % cyclohexanedimethanol; 25 to 65 mole % 2,2,4,4-tetramethyl-1,3-cyclobutanediol and 35 to 75 mole % cyclohexanedimethanol; 25 to 60 mole % 2,2,4,4-tetramethyl-1,3-cyclobutanediol and 40 to 75 mole % cyclohexanedimethanol; 25 to 55 mole % 2,2,4,4-tetramethyl-1,3-cyclobutanediol and 45 to 75 mole % cyclohexanedimethanol; 25 to 50 mole % 2,2,4,4-tetramethyl-1,3-cyclobutanediol and 50 to 75 mole % cyclohexanedimethanol; 25 to less than 50 mole % 2,2,4,4-tetramethyl-1,3-cyclobutanediol and greater than 50 to 75 mole % cyclohexanedimethanol; 25 to 45 mole % 2,2,4,4-tetramethyl-1,3-cyclobutanediol and 55 to 75 mole % cyclohexanedimethanol; 25 to 40 mole % 2,2,4,4-tetramethyl-1,3-cyclobutanediol and 60 to 75 mole % cyclohexanedimethanol; 25 to 35 mole % 2,2,4,4-tetramethyl-1,3-cyclobutanediol and 65 to 75 mole % cyclohexanedimethanol; and 25 to 30 mole % 2,2,4,4-tetramethyl-1,3-cyclobutanediol and 70 to 75 mole % cyclohexanedimethanol.

In other aspects of the invention, the glycol component for the AAPE polyesters useful in the blends of the invention include but are not limited to at least one of the following combinations of ranges: 30 to 99 mole % 2,2,4,4-tetramethyl-1,3-cyclobutanediol and 1 to 70 mole % cyclohexanedimethanol; 30 to 95 mole % 2,2,4,4-tetramethyl-1,3-cyclobutanediol and 5 to 70 mole % cyclohexanedimethanol; 30 to 90 mole % 2,2,4,4-tetramethyl-1,3-cyclobutanediol and 10 to 70 mole % cyclohexanedimethanol; 30 to 85 mole % 2,2,4,4-tetramethyl-1,3-cyclobutanediol and 15 to 70 mole % cyclohexanedimethanol; 30 to 80 mole % 2,2,4,4-tetramethyl-1,3-cyclobutanediol and 20 to 70 mole % cyclohexanedimethanol; 30 to 75 mole % 2,2,4,4-tetramethyl-1,3-cyclobutanediol and 25 to 70 mole % cyclohexanedimethanol; 30 to 70 mole % 2,2,4,4-tetramethyl-1,3-cyclobutanediol and 30 to 70 mole % cyclohexanedimethanol; 30 to 65 mole % 2,2,4,4-tetramethyl-1,3-cyclobutanediol and 35 to 70 mole % cyclohexanedimethanol; 30 to 60 mole % 2,2,4,4-tetramethyl-1,3-cyclobutanediol and 40 to 70 mole % cyclohexanedimethanol; 30 to 55 mole % 2,2,4,4-tetramethyl-1,3-cyclobutanediol and 45 to 70 mole % cyclohexanedimethanol; 30 to 50 mole % 2,2,4,4-tetramethyl-1,3-cyclobutanediol and 50 to 70 mole % cyclohexanedimethanol; 30 to less than 50 mole % 2,2,4,4-tetramethyl-1,3-cyclobutanediol and greater than 50 to 70 mole % cyclohexanedimethanol; 30 to 45 mole % 2,2,4,4-tetramethyl-1,3-cyclobutanediol and 55 to 70 mole % cyclohexanedimethanol; 30 to 40 mole % 2,2,4,4-tetramethyl-1,3-cyclobutanediol and 60 to 70 mole % cyclohexanedimethanol; 30 to 35 mole % 2,2,4,4-tetramethyl-1,3-cyclobutanediol and 65 to 70 mole % cyclohexanedimethanol; 31 to 35 mole % 2,2,4,4-tetramethyl-1,3-cyclobutanediol and 65 to 69 mole % cyclohexanedimethanol.

In other aspects of the invention, the glycol component for the AAPE polyesters useful in the blends of the invention include but are not limited to at least one of the following combinations of ranges: 35 to 99 mole % 2,2,4,4-tetramethyl-1,3-cyclobutanediol and 1 to 65 mole % cyclohexanedimethanol; 35 to 95 mole % 2,2,4,4-tetramethyl-1,3-cyclobutanediol and 5 to 65 mole % cyclohexanedimethanol; 35 to 90 mole % 2,2,4,4-tetramethyl-1,3-cyclobutanediol and 10 to 65 mole % cyclohexanedimethanol; 35 to 85 mole % 2,2,4,4-tetramethyl-1,3-cyclobutanediol and 15 to 65 mole % cyclohexanedimethanol; 35 to 80 mole % 2,2,4,4-tetramethyl-1,3-cyclobutanediol and 20 to 65 mole % cyclohexanedimethanol; 35 to 75 mole % 2,2,4,4-tetramethyl-1,3-cyclobutanediol and 25 to 65 mole % cyclohexanedimethanol; 35 to 70 mole % 2,2,4,4-tetramethyl-1,3-cyclobutanediol and 30 to 65 mole % cyclohexanedimethanol; 35 to 65 mole % 2,2,4,4-tetramethyl-1,3-cyclobutanediol and 35 to 65 mole % cyclohexanedimethanol; 35 to 60 mole % 2,2,4,4-tetramethyl-1,3-cyclobutanediol and 40 to 65 mole % cyclohexanedimethanol; 35 to 55 mole % 2,2,4,4-tetramethyl-1,3-cyclobutanediol and 45 to 65 mole % cyclohexanedimethanol; 35 to 50 mole % 2,2,4,4-tetramethyl-1,3-cyclobutanediol and 50 to 65 mole % cyclohexanedimethanol; 35 to less than 50 mole % 2,2,4,4-tetramethyl-1,3-cyclobutanediol and greater than 50 to 65 mole % cyclohexanedimethanol; 35 to 45 mole % 2,2,4,4-tetramethyl-1,3-cyclobutanediol and 55 to 65 mole % cyclohexanedimethanol; 35 to 40 mole % 2,2,4,4-tetramethyl-1,3-cyclobutanediol and 60 to 65 mole % cyclohexanedimethanol.

In other aspects of the invention, the glycol component for the AAPE polyesters useful in the blends of the invention include but are not limited to at least one of the following combinations of ranges: 40.1 to 100 mole % 2,2,4,4-tetramethyl-1,3-cyclobutanediol and 1 to 59.9 mole % cyclohexanedimethanol 40 to 99 mole % 2,2,4,4-tetramethyl-1,3-cyclobutanediol and 1 to 60 mole % cyclohexanedimethanol; 40 to 95 mole % 2,2,4,4-tetramethyl-1,3-cyclobutanediol and 5 to 60 mole % cyclohexanedimethanol; 40 to 90 mole % 2,2,4,4-tetramethyl-1,3-cyclobutanediol and 10 to 60 mole % cyclohexanedimethanol; 40 to 85 mole % 2,2,4,4-tetramethyl-1,3-cyclobutanediol and 15 to 60 mole % cyclohexanedimethanol; 40 to 80 mole % 2,2,4,4-tetramethyl-1,3-cyclobutanediol and 20 to 60 mole % cyclohexanedimethanol; 40 to 75 mole % 2,2,4,4-tetramethyl-1,3-cyclobutanediol and 25 to 60 mole % cyclohexanedimethanol; 40 to 70 mole % 2,2,4,4-tetramethyl-1,3-cyclobutanediol and 30 to 60 mole % cyclohexanedimethanol; 40 to 65 mole % 2,2,4,4-tetramethyl-1,3-cyclobutanediol and 35 to 60 mole % cyclohexanedimethanol; 40 to 60 mole % 2,2,4,4-tetramethyl-1,3-cyclobutanediol and 40 to 60 mole % cyclohexanedimethanol; 40 to 55 mole % 2,2,4,4-tetramethyl-1,3-cyclobutanediol and 45 to 60 mole % cyclohexanedimethanol; 40 to less than 50 mole % 2,2,4,4-tetramethyl-1,3-cyclobutanediol and greater than 50 to 60 mole % cyclohexanedimethanol; 40 to 50 mole % 2,2,4,4-tetramethyl-1,3-cyclobutanediol and 50 to 60 mole % cyclohexanedimethanol; and 40 to 45 mole % 2,2,4,4-tetramethyl-1,3-cyclobutanediol and 55 to 60 mole % cyclohexanedimethanol.

In other aspects of the invention, the glycol component for the AAPE polyesters useful in the blends of the invention include but are not limited to at least one of the following combinations of ranges: 45 to 100 mole % 2,2,4,4-tetramethyl-1,3-cyclobutanediol and 0 to 55 mole % cyclohexanedimethanol; 45 to 99 mole % 2,2,4,4-tetramethyl-1,3-cyclobutanediol and 1 to 55 mole % cyclohexanedimethanol; 45 to 95 mole % 2,2,4,4-tetramethyl-1,3-cyclobutanediol and 5 to 55 mole % cyclohexanedimethanol; 45 to 90 mole % 2,2,4,4-tetramethyl-1,3-cyclobutanediol and 10 to 55 mole % cyclohexanedimethanol; 45 to 85 mole % 2,2,4,4-tetramethyl-1,3-cyclobutanediol and 15 to 55 mole % cyclohexanedimethanol; 45 to 80 mole % 2,2,4,4-tetramethyl-1,3-cyclobutanediol and 20 to 55 mole % cyclohexanedimethanol; 45 to 75 mole % 2,2,4,4-tetramethyl-1,3-cyclobutanediol and 25 to 55 mole % cyclohexanedimethanol; 45 to 70 mole % 2,2,4,4-tetramethyl-1,3-cyclobutanediol and 30 to 55 mole % cyclohexanedimethanol; 45 to 65 mole % 2,2,4,4-tetramethyl-1,3-cyclobutanediol and 35 to 55 mole % cyclohexanedimethanol; 45 to 60 mole % 2,2,4,4-tetramethyl-1,3-cyclobutanediol and 40 to 55 mole % cyclohexanedimethanol; greater than 45 to 55 mole % 2,2,4,4-tetramethyl-1,3-cyclobutanediol and 45 to less than 55 mole % cyclohexanedimethanol; 45 to 55 mole % 2,2,4,4-tetramethyl-1,3-cyclobutanediol and 45 to 55 mole % cyclohexanedimethanol; and 45 to 50 mole % 2,2,4,4-tetramethyl-1,3-cyclobutanediol and 50 to 60 mole % cyclohexanedimethanol.

In other aspects of the invention, the glycol component for the AAPE polyesters useful in the polymer blends of the invention include but are not limited to at least one of the following combinations of ranges: 55 to 99 mole % 2,2,4,4-tetramethyl-1,3-cyclobutanediol and 1 to 45 mole % cyclohexanedimethanol; 55 to 95 mole % 2,2,4,4-tetramethyl-1,3-cyclobutanediol and 5 to 45 mole % cyclohexanedimethanol; 55 to 90 mole % 2,2,4,4-tetramethyl-1,3-cyclobutanediol and 10 to 45 mole % cyclohexanedimethanol; 55 to 85 mole % 2,2,4,4-tetramethyl-1,3-cyclobutanediol and 15 to 45 mole % cyclohexanedimethanol; 55 to 80 mole % 2,2,4,4-tetramethyl-1,3-cyclobutanediol and 20 to 45 mole % cyclohexanedimethanol; 55 to 75 mole % 2,2,4,4-tetramethyl-1,3-cyclobutanediol and 25 to 45 mole % cyclohexanedimethanol; 55 to 70 mole % 2,2,4,4-tetramethyl-1,3-cyclobutanediol and 30 to 45 mole % cyclohexanedimethanol; 55 to 65 mole % 2,2,4,4-tetramethyl-1,3-cyclobutanediol and 35 to 45 mole % cyclohexanedimethanol; and 55 to 60 mole % 2,2,4,4-tetramethyl-1,3-cyclobutanediol and 40 to 45 mole % cyclohexanedimethanol.

In other aspects of the invention, the glycol component for the AAPE polyesters useful in the polymer blends of the invention include but are not limited to at least one of the following combinations of ranges: 60 to 99 mole % 2,2,4,4-tetramethyl-1,3-cyclobutanediol and 1 to 40 mole % cyclohexanedimethanol; 60 to 95 mole % 2,2,4,4-tetramethyl-1,3-cyclobutanediol and 5 to 40 mole % cyclohexanedimethanol; 60 to 90 mole % 2,2,4,4-tetramethyl-1,3-cyclobutanediol and 10 to 40 mole % cyclohexanedimethanol; 60 to 85 mole % 2,2,4,4-tetramethyl-1,3-cyclobutanediol and 15 to 40 mole % cyclohexanedimethanol; 60 to 80 mole % 2,2,4,4-tetramethyl-1,3-cyclobutanediol and 20 to 40 mole % cyclohexanedimethanol; 60 to 75 mole % 2,2,4,4-tetramethyl-1,3-cyclobutanediol and 25 to 40 mole % cyclohexanedimethanol; and 60 to 70 mole % 2,2,4,4-tetramethyl-1,3-cyclobutanediol and 30 to 40 mole % cyclohexanedimethanol.

In other aspects of the invention, the glycol component for the polyesters useful in the polymer blends of the invention include but are not limited to at least one of the following combinations of ranges: 65 to 99 mole % 2,2,4,4-tetramethyl-1,3-cyclobutanediol and 1 to 35 mole % cyclohexanedimethanol; 65 to 95 mole % 2,2,4,4-tetramethyl-1,3-cyclobutanediol and 5 to 35 mole % cyclohexanedimethanol; 65 to 90 mole % 2,2,4,4-tetramethyl-1,3-cyclobutanediol and 10 to 35 mole % cyclohexanedimethanol; 65 to 85 mole % 2,2,4,4-tetramethyl-1,3-cyclobutanediol and 15 to 35 mole % cyclohexanedimethanol; 65 to 80 mole % 2,2,4,4-tetramethyl-1,3-cyclobutanediol and 20 to 35 mole % cyclohexanedimethanol; 65 to 75 mole % 2,2,4,4-tetramethyl-1,3-cyclobutanediol and 25 to 35 mole % cyclohexanedimethanol; and 65 to 70 mole % 2,2,4,4-tetramethyl-1,3-cyclobutanediol and 30 to 35 mole % cyclohexanedimethanol.

In other aspects of the invention, the glycol component for the polyesters useful in the polymer blends of the invention include but are not limited to at least one of the following combinations of ranges: 70 to 99 mole % 2,2,4,4-tetramethyl-1,3-cyclobutanediol and 1 to 30 mole % cyclohexanedimethanol; 70 to 95 mole % 2,2,4,4-tetramethyl-1,3-cyclobutanediol and 5 to 30 mole % cyclohexanedimethanol; 70 to 90 mole % 2,2,4,4-tetramethyl-1,3-cyclobutanediol and 10 to 30 mole % cyclohexanedimethanol; 70 to 85 mole % 2,2,4,4-tetramethyl-1,3-cyclobutanediol and 15 to 30 mole % cyclohexanedimethanol; 70 to 80 mole % 2,2,4,4-tetramethyl-1,3-cyclobutanediol and 20 to 30 mole % cyclohexanedimethanol; 70 to 75 mole % 2,2,4,4-tetramethyl-1,3-cyclobutanediol and 25 to 30 mole % cyclohexanedimethanol.

In other aspects of the invention, the glycol component for the AAPE polyesters useful in the polymer blends of the invention include but are not limited to at least one of the following combinations of ranges: 75 to 99 mole % 2,2,4,4-tetramethyl-1,3-cyclobutanediol and 1 to 25 mole % cyclohexanedimethanol; 75 to 95 mole % 2,2,4,4-tetramethyl-1,3-cyclobutanediol and 5 to 25 mole % cyclohexanedimethanol; 75 to 90 mole % 2,2,4,4-tetramethyl-1,3-cyclobutanediol and 10 to 25 mole % cyclohexanedimethanol; and 75 to 85 mole % 2,2,4,4-tetramethyl-1,3-cyclobutanediol and 15 to 25 mole % cyclohexanedimethanol.

In other aspects of the invention, the glycol component for the AAPE polyesters useful in the polymer blends of the invention include but are not limited to at least one of the following combinations of ranges: 80 to 99 mole % 2,2,4,4-tetramethyl-1,3-cyclobutanediol and 1 to 20 mole % cyclohexanedimethanol; 80 to 95 mole % 2,2,4,4-tetramethyl-1,3-cyclobutanediol and 5 to 20 mole % cyclohexanedimethanol; 80 to 90 mole % 2,2,4,4-tetramethyl-1,3-cyclobutanediol and 10 to 20 mole % cyclohexanedimethanol.

In other aspects of the invention, the glycol component for the AAPE polyesters useful in the polymer blends of the invention include but are not limited to at least one of the following combinations of ranges 37 to 80 mole % 2,2,4,4-tetramethyl-1,3-cyclobutanediol and 20 to 63 mole % cyclohexanedimethanol; 40 to less than 45 mole % 2,2,4,4-tetramethyl-1,3-cyclobutanediol and greater than 55 to 60 mole % cyclohexanedimethanol; greater than 45 to 55 mole % 2,2,4,4-tetramethyl-1,3-cyclobutanediol and 45 to less than 55 mole % cyclohexanedimethanol; and 46 to 55 mole % 2,2,4,4-tetramethyl-1,3-cyclobutanediol and 45 to 54 mole % cyclohexanedimethanol; and 46 to 65 mole % 2,2,4,4-tetramethyl-1,3-cyclobutanediol and 35 to 54 mole % cyclohexanedimethanol.

In other aspects of the invention, the glycol component for the AAPE polyesters useful in the invention include but are not limited to at least one of the following combinations of ranges: 20 to 40 mole % 2,2,4,4-tetramethyl-1,3-cyclobutanediol, 20 to 40 mole % cyclohexanedimethanol and 30 to 60 mole % ethylene glycol; 20 to 35 mole % 2,2,4,4-tetramethyl-1,3-cyclobutanediol, 20 to 40 mole % cyclohexanedimethanol and 30 to 60 mole % ethylene glycol; 20 to 30 mole % 2,2,4,4-tetramethyl-1,3-cyclobutanediol, 20 to 40 mole % cyclohexanedimethanol and 30 to 60 mole % ethylene glycol; and 20 to 25 mole % 2,2,4,4-tetramethyl-1,3-cyclobutanediol, 20 to 40 mole % cyclohexanedimethanol and 30 to 60 mole % ethylene glycol.

In other aspects of the invention, the glycol component for the AAPE polyesters useful in the invention include but are not limited to at least one of the following combinations of ranges: 25 to 40 mole % 2,2,4,4-tetramethyl-1,3-cyclobutanediol, 20 to 40 mole % cyclohexanedimethanol and 30 to 55 mole % ethylene glycol; 25 to 35 mole % 2,2,4,4-tetramethyl-1,3-cyclobutanediol, 120 to 40 mole % cyclohexanedimethanol and 30 to 55 mole % ethylene glycol; and 25 to 30 mole % 2,2,4,4-tetramethyl-1,3-cyclobutanediol, 20 to 40 mole % cyclohexanedimethanol and 30 to 55 mole % ethylene glycol.

In other aspects of the invention, the glycol component for the AAPE polyesters useful in the invention include but are not limited to at least one of the following combinations of ranges: 30 to 40 mole % 2,2,4,4-tetramethyl-1,3-cyclobutanediol, 20 to 40 mole % cyclohexanedimethanol and 30 to 50 mole % ethylene glycol; 30 to 35 mole % 2,2,4,4-tetramethyl-1,3-cyclobutanediol, 20 to 40 mole % cyclohexanedimethanol and 30 to 50 mole % ethylene glycol.

In other aspects of the invention, the glycol component for the AAPE polyesters useful in the invention include but are not limited to at least one of the following combinations of ranges: 20 to 40 mole % 2,2,4,4-tetramethyl-1,3-cyclobutanediol, 20 to 35 mole % cyclohexanedimethanol and 30 to 60 mole % ethylene glycol; 20 to 40 mole % 2,2,4,4-tetramethyl-1,3-cyclobutanediol, 20 to 30 mole % cyclohexanedimethanol and 30 to 60 mole % ethylene glycol; and 20 to 40 mole % 2,2,4,4-tetramethyl-1,3-cyclobutanediol, 20 to 25 mole % cyclohexanedimethanol and 30 to 60 mole % ethylene glycol.

In other aspects of the invention, the glycol component for the AAPE polyesters useful in the invention include but are not limited to at least one of the following combinations of ranges: 20 to 40 mole % 2,2,4,4-tetramethyl-1,3-cyclobutanediol, 25 to 40 mole % cyclohexanedimethanol and 30 to 55 mole % ethylene glycol; 20 to 40 mole % 2,2,4,4-tetramethyl-1,3-cyclobutanediol, 25 to 35 mole % cyclohexanedimethanol and 30 to 55 mole % ethylene glycol; and 20 to 40 mole % 2,2,4,4-tetramethyl-1,3-cyclobutanediol, 25 to 30 mole % cyclohexanedimethanol and 30 to 55 mole % ethylene glycol.

In other aspects of the invention, the glycol component for the AAPE polyesters useful in the invention include but are not limited to at least one of the following combinations of ranges: 20 to 40 mole % 2,2,4,4-tetramethyl-1,3-cyclobutanediol, 30 to 40 mole % cyclohexanedimethanol and 30 to 50 mole % ethylene glycol; 20 to 40 mole % 2,2,4,4-tetramethyl-1,3-cyclobutanediol, 30 to 35 mole % cyclohexanedimethanol and 30 to 50 mole % ethylene glycol.

In one embodiment, the glycol component of the AAPE polyester(s) useful in the invention comprises 2,2,4,4-tetramethyl-1,3-cyclobutanediol and cyclohexanedimethanol wherein the sum of the mole percentages of 2,2,4,4-tetramethyl-1,3-cyclobutanediol and cyclohexanedimethanol is from 40 to less than 70 mole % of the total mole % of the total glycol component.

In certain embodiments, terephthalic acid or an ester thereof, such as, for example, dimethyl terephthalate or a mixture of terephthalic acid residues and an ester thereof can make up a portion or all of the dicarboxylic acid component used to form the polyesters useful in the invention. In certain embodiments, terephthalic acid residues can make up a portion or all of the dicarboxylic acid component used to form the polyesters useful in the invention. In certain embodiments, higher amounts of terephthalic acid can be used in order to produce a higher impact strength polyester. For purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the polyer blends of the invention. In all embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, the dicarboxylic acid component of the AAPE polyesters useful in the polymer blends of the invention can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the AAPE polyesters useful in the polymer blends of the invention can be further modified with up to 10 mole %, such as up to 5 mole % or up to 1 mole % of one or more aliphatic dicarboxylic acids containing 2-16 carbon atoms, such as, for example, cyclohexanedicarboxylic, malonic, succinic, glutaric, adipic, pimelic, suberic, azelaic and dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the invention.

The modifying dicarboxylic acids useful in the AAPE polyesters of the invention can include indan dicarboxylic acids, for example, indan-1,3-dicarboxylic acids and/or phenylindan dicarboxylic acids. In one embodiment, the dicarboxylic acid may be chosen from at least one of 1,2,3-trimethyl-3-phenylindan-4′,5-dicarboxylic acid and 1,1,3-trimethyl-5-carboxy-3-(4-carboxyphenyl)indan dicarboxylic acid. For the purposes of this invention, any of the indan dicarboxylic acids described in United States Patent Application Publication No. 2006/0004151A1 entitled “Copolymers Containing Indan Moieties and Blends Thereof” by Shaikh et al., assigned to General Electric Company may be used as at least one modifying dicarboxylic acid within the scope of this invention; United States Patent Application Publication No. 2006/0004151A1 is incorporated herein by reference with respect to any of the indan dicarboxylic acids described therein.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The AAPE polyesters useful in the polymer blends of the invention can be amorphous or semicrystalline. In one aspect, certain AAPE polyesters useful in the invention can have relatively low crystallinity. Certain AAPE polyesters useful in the invention can thus have a substantially amorphous morphology, meaning that the AAPE polyesters comprise substantially unordered regions of polymer.

The AAPE polyesters useful in the invention can possess one or more of the following properties: In one embodiment, the AAPE polyesters useful in the invention exhibit a notched Izod impact strength of at least 150 J/m (3 ft-lb/in) at 23° C. with a 10-mil notch in a 3.2 mm (⅛-inch) thick bar determined according to ASTM D256; in one embodiment, the AAPE polyesters useful in the invention exhibit a notched Izod impact strength of at least (400 J/m) 7.5 ft-lb/in at 23° C. with a 10-mil notch in a 3.2 mm (⅛-inch) thick bar determined according to ASTM D256; in one embodiment, the AAPE polyesters useful in the invention exhibit a notched Izod impact strength of at least 1000 J/m (18 ft-lb/in) at 23° C. with a 10-mil notch in a 3.2 mm (⅛-inch) thick bar determined according to ASTM D256. In one embodiment, the AAPE polyesters useful in the invention exhibit a notched Izod impact strength of at least 150 J/m (3 ft-lb/in) at 23° C. with a 10-mil notch in a 6.4 mm (¼-inch) thick bar determined according to ASTM D256; in one embodiment, the AAPE polyesters useful in the invention exhibit a notched Izod impact strength of at least (400 J/m) 7.5 ft-lb/in at 23° C. with a 10-mil notch in a 6.4 mm (¼-inch) thick bar determined according to ASTM D256; in one embodiment, the AAPE polyesters useful in the invention exhibit a notched Izod impact strength of at least 1000 J/m (18 ft-lb/in) at 23° C. with a 10-mil notch in a 6.4 mm (¼-inch) thick bar determined according to ASTM D256.

In one embodiment, AAPE polyesters of this invention exhibit superior notched toughness in thick sections. When tested by the Notched Izod impact strength test method of ASTM D256, AAPE polymers can exhibit either a complete break failure mode, where the test specimen breaks into two distinct parts, or a partial or no break failure mode, where the test specimen remains as one part. The complete break failure mode is associated with low energy failure. The partial and no break failure modes are associated with high energy failure. A typical thickness used to measure Notched Izod impact strength is ⅛″. At this thickness, very few polymers are believed to exhibit a partial or no break failure mode, polycarbonate being one notable example. When the thickness of the test specimen is increased to ¼″, however, no commercial amorphous materials exhibit a partial or no break failure mode. In one embodiment, AAPE polyesters useful in the present invention exhibit a no break failure mode when tested in the Notched Izod impact strength test method using a ¼″ thick specimen.

The AAPE polyesters useful in the invention in general may be prepared by condensing the dicarboxylic acid or dicarboxylic acid ester with the glycol in the presence of the tin catalyst described herein at elevated temperatures increased gradually during the course of the condensation up to a temperature of about 225°-310° C., in an inert atmosphere, and conducting the condensation at low pressure during the latter part of the condensation, as described in further detail in U.S. Pat. No. 2,720,507 incorporated herein by reference.

### Additional Aliphatic Polyester Description

In one embodiment, cyclohexanedicarboxylic acid residues make up part or all of the dicarboxylic acid component used to make the aliphatic polyesters useful in the present invention. In certain embodiments, ranges of from 70 to 100 mole %; or 80 to 100 mole %; or 90 to 100 mole %; or 99 to 100 mole %; or 100 mole % cyclohexanedicarboxylic acid residues and/or esters thereof and/or mixtures thereof may be used.

In one embodiment, 1,4-cyclohexanedicarboxylic acid esters make up part or all of the dicarboxylic acid component used to make the aliphatic polyesters useful in the present invention. In certain embodiments, ranges of from 70 to 100 mole %; or 80 to 100 mole %; or 90 to 100 mole %; or 99 to 100 mole %; or 100 mole % 1,4-cyclohexanedicarboxylic acid esters may be used.

In one embodiment, di methyl-1,4-cyclohexanedicarboxylate (DMCD) makes up part or all of the dicarboxylic acid component used to make the aliphatic polyesters useful in the present invention. In certain embodiments, ranges of from 70 to 100 mole %; or 80 to 100 mole %; or 90 to 100 mole %; or 99 to 100 mole %; or 100 mole % dimethyl-1,4-cyclohexanedicarboxylate may be used.

As used herein, the term “cyclohexanedicarboxylic acid” is intended to include cyclohexanedicarboxylic acid itself and residues thereof as well as any derivative or isomer of cyclohexanedicarboxylic acid, including its associated esters, half-esters, salts, half-salts and/or mixtures thereof or equivalents thereof. Any of 1,1-, 1,2-, 1,3-, 1,4-isomers of cyclohexanedicarboxylic acids or esters thereof or mixtures thereof may be present in the aliphatic acid component of this invention. Cis and trans isomers do not exist for 1,1-cyclohexanedicarboxylic acid.

In other aspects of the invention, the Tg of the aliphatic polyesters useful in the polyester compositions of the invention can be at least one of the following ranges: 50 to 100° C.; 50 to 95° C.; 50 to 90° C.; 50 to 85° C.; 50 to 80° C.; 50 to 75° C.; 50 to 70° C.; 50 to 65° C.; 55 to 100° C.; 55 to 95° C.; 55 to 90° C.; 55 to 85° C.; 55 to 80° C.; 55 to 75° C.; 55 to 70° C.; 55 to 65° C.; 60 to 100° C.; 60 to 95° C.; 60 to 90° C.; 60 to 85° C.; 60 to 80° C.; 60 to 75° C.; 60 to 70° C.; 60 to 65° C.; 65 to 100° C.; 65 to 95° C.; 65 to 90° C.; 65 to 85° C.; 65 to 80° C.; 65 to 75° C.; 65 to 70° C.; 70 to 100° C.; 70 to 95° C.; 70 to 90° C.; 70 to 85° C.; 70 to 80° C.; 70 to 75° C.; 75 to 100° C.; 75 to 95° C.; 75 to 90° C.; 75 to 85° C.; 75 to 80° C.; 80 to 100° C.; 80 to 95° C.; 80 to 90° C.; 80 to 85° C.; 85 to 100° C.; 85 to 95° C.; 85 to 90° C.; 90 to 100° C.; 90 to 95° C.; and 95 to 100° C.

In other aspects of the invention, the glycol component for the aliphatic polyesters useful in the invention can include but are not limited to at least one of the following combinations of ranges: 0 to 20 mole % 2,2,4,4-tetramethyl-1,3-cyclobutanediol and 80 to 100 mole % cyclohexanedimethanol; 5 to 20 mole % 2,2,4,4-tetramethyl-1,3-cyclobutanediol and 80 to 95 mole % cyclohexanedimethanol.

In other aspects of the invention, the glycol component for the aliphatic polyesters useful in the invention can include but are not limited to at least one of the following combinations of ranges: 5 to 15 mole % 2,2,4,4-tetramethyl-1,3-cyclobutanediol and 85 to 95 mole % cyclohexanedimethanol; 5 to 10 mole % 2,2,4,4-tetramethyl-1,3-cyclobutanediol and 90 to 95 mole % cyclohexanedimethanol; 10 to 20 mole % 2,2,4,4-tetramethyl-1,3-cyclobutanediol and 80 to 90 mole % cyclohexanedimethanol.

In addition to cyclohexanedicarboxylic acid, the dicarboxylic acid component of the polyesters useful in the invention can comprise up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, terephthalic acid, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid. In one embodiment, the modifying aromatic dicarboxylic acid is terephthalic acid.

As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

In certain embodiments, terephthalic acid or an ester thereof, such as, for example, dimethyl terephthalate or a mixture of terephthalic acid residues and an ester thereof can make up a portion or all of the aromatic dicarboxylic acid component, if any, used to form the polyesters useful in the invention. In certain embodiments, terephthalic acid residues can make up a portion or all of the aromatic dicarboxylic acid component, if any, used to form the polyesters useful in the invention. For purposes of this disclosure, the terms “terephthalic acid” and “dimethyl terephthalate” are used interchangeably herein. In one embodiment, dimethyl terephthalate is part or all of the aromatic dicarboxylic acid component, if any, used to make the polyesters useful in the present invention.

The carboxylic acid component of the polyesters useful in the invention can be further modified with up to 30 mole %, such as up to 25 mole % or such as up to 20 mole % such as up tol 5 mole % or such as up to 10 mole % or such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is equal to 100 mole %. In one embodiment, adipic acid and/or glutaric acid are provided in the modifying aliphatic dicarboxylic acid component of the invention.

Esters of dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and In one embodiment, the glycol component of the polyester portion of the polyester compositions useful in the invention can contain 20 mole % or less of one or more modifying glycols which are not 2,2,4,4-tetramethyl-1,3-cyclobutanediol or cyclohexanedimethanol; in one embodiment, the polyesters useful in the invention may contain less than 15 mole % or of one or more modifying glycols. In another embodiment, the polyesters useful in the invention can contain 10 mole % or less of one or more modifying glycols. In another embodiment, the polyesters useful in the invention can contain 5 mole % or less of one or more modifying glycols. In another embodiment, the polyesters useful in the invention can contain 3 mole % or less of one or more modifying glycols. In another embodiment, the polyesters useful in the invention can contain 2 mole % or less of one or more modifying glycols. In another embodiment, the polyesters useful in the invention can contain 0 mole % modifying glycols.

### Articles of the Invention

In one embodiment, this invention includes articles of manufacture comprising any of the polyester blends of the invention.

The invention further relates to the film(s) and/or sheet(s) comprising the polyester blends. The methods of forming the polyesters into film(s) and/or sheet(s) are well known in the art. Examples of film(s) and/or sheet(s) of the invention including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting. In one embodiment, this invention includes articles of manufacture comprising the polyester blends of the invention.

In one embodiment, this invention includes articles of manufacture comprising any of the polyester blends of the invention which is extrusion molded.

In one embodiment, this invention includes articles of manufacture comprising any of the polyester blends of the invention which is extrusion stretch blow molded.

In one embodiment, this invention includes articles of manufacture comprising any of the polyester blends of the invention which is injection molded.

In one embodiment, this invention includes articles of manufacture comprising the polyester blends of the invention which is injection blow molded.

In one embodiment, this invention includes articles of manufacture comprising the polyester blends of the invention which is injection stretch blow molded.

In one embodiment, the article of manufacture included in this invention are visually clear comprising any of the polyester blends of the invention.

Examples of potential articles made from the polymer blends useful in the invention include, but are not limited, to uniaxially stretched film, biaxially stretched film, shrink film (whether or not uniaxially or biaxially stretched), liquid crystal display film (including, but not limited to, diffuser sheets, compensation films, brightness enhancing films, and protective films), thermoformed sheet, graphic arts film, outdoor signs, skylights, coating(s), coated articles, painted articles, laminates, laminated articles, and/or multiwall films or sheets.

### EXAMPLES

The invention is further illustrated by the following examples. Inherent viscosities (IV) were measured in 60/40 (wt/wt) phenol/tetrachloroethane at a concentration of 0.25 g/50 ml at 25° C. according to standard methods that are described in ASTM Method D4603. The inherent viscosity of the polyesters was determined in 60/40 (wt/wt) phenol/tetrachloroethane at a concentration of 0.5 g/100 ml at 25° C. The glass transition temperatures were determined using a Perkin Elmer differential scanning calorimeter (DSC) at a scan rate of 20° C. The composition of the neat resins was determined by proton nuclear magnetic resonance spectroscopy (NMR). The miscibility of the blends was determined by the presence of a single glass transition and clarity of molded bars. As referred to herein, Eastar 6763 is a copolyester comprising 31 mole % 1,4-cyclohexanedimethanol residues, 69 mole % ethylene glycol residues and 100 mole % terephthalic acid residues.

### Example 1 of the Invention

The aliphatic-aromatic copolyester used contained terephthalic acid, 46.0 mol % 2,2,4,4, tetramethyl-1,3 cyclobutanediol (46.1 mol % cis isomer), 54% cyclohexanedimethanol. The inherent viscosity was measured to be 0.59. The aliphatic polyester used contained 1,4 cyclohexanedimethanol (30.4 mol % cis isomer) and 1,4 cyclohexane dicarboxylicacid (7.2 mol % cis isomer) and had a measured inherent viscosity of 0.94.

The aliphatic-aromatic copolyester was dried at 90° C. and the aliphatic polyester was dried at 70° C. Blends were prepared in a 19 mm Leistritz twin screw extruder. The polyesters were premixed by tumble blending and fed into the extruder and the extruded strand was pelletized. The pellets were injection molded into parts on a Toyo 90 injection molding machine. The extruder was run at 350 rpms at a feed rate to give a machine torque between 80-100%. Processing temperatures used were in the range of 240° C. to 270° C. The compositions and properties of the blends are shown in Table 1.

Heat deflection temperature, at 264 psi, was determined according to ASTM D648. Flexural modulus and flexural strength were determined according to ASTM D790. Tensile properties were determined according to ASTM D638.

TABLE 1

| | UNITS | | | | | | | |
|---|---|---|---|---|---|---|---|---|
| Weight % Aliphatic-aromatic | % | 0 | 15 | 30 | 50 | 70 | 85 | 100 |
| polyester | | | | | | | | |
| Weight % Aliphatic polyester | % | 100 | 85 | 70 | 50 | 30 | 15 | 0 |
| Heat Deflection Temperature 264 Psi | (deg C.) | 53 | 57 | 64 | 70 | 82 | 93 | 100 |
| Tensile Strength | MPa | 36 | 37 | 39 | 42 | 44 | 46 | 47 |
| Tensile Break Elongation | % | 411 | 320 | 269 | 155 | 140 | 118 | 99 |
| Flexural Modulus | MPa | 1011 | 1070 | 1093 | 1168 | 1303 | 1372 | 1402 |
| Flexural Strength | MPa | 44 | 45 | 47 | 50 | 54 | 57 | 59 |
| DSC Tg (Second Cycle) | ° C. | 63 | 74 | 83 | 92 | 105 | 118 | 128 |
| Visual Clarity | | Clear | Clear | Clear | Clear | Clear | Clear | Clear |

### Example 2 of the Invention

The aliphatic-aromatic copolyester used contained terephthalic acid, 25.1 mol % 2,2,4,4, tetramethyl-1,3 cyclobutanediol (50.1% cis isomer), 74.9% cyclohexanedimethanol. The inherent viscosity was measured to be 0.66. The aliphatic polyester used contained 1,4 cyclohexanedimethanol (30.4 mol % cis isomer) and 1,4 cyclohexane dicarboxylicacid (7.2 mol % cis isomer) and had a measured inherent viscosity of 0.94.

The aliphatic-aromatic copolyester was dried at 90° C. and the aliphatic polyester was dried at 70° C. Blends were prepared in a 19 mm Leistritz twin screw extruder. The polyesters were premixed by tumble blending and fed into the extruder and the extruded strand was pelletized. The pellets were injection molded into parts on a Toyo 90 injection molding machine. The extruder was run at 350 rpms at a feed rate to give a machine torque between 80-100%. Processing temperatures used were in the range of 240° C. to 260° C. The compositions and properties of the blends are shown in Table 2.

TABLE 2

| | UNITS | | | | | | | |
|---|---|---|---|---|---|---|---|---|
| Weight % Aliphatic-aromatic | % | 0 | 15 | 30 | 50 | 70 | 85 | 100 |
| polyester | | | | | | | | |
| Weight % Aliphatic polyester | % | 100 | 85 | 70 | 50 | 30 | 15 | 0 |
| Heat Deflection Temperature 264 Psi | (deg C.) | 56 | 58 | 62 | 66 | 71 | 76 | 81 |
| Tensile Strength | MPa | 35 | 36 | 37 | 39 | 41 | 43 | 44 |
| Tensile Break Elongation | % | 262 | 300 | 323 | 288 | 224 | 199 | 152 |
| Flexural Modulus | MPa | 1011 | 1070 | 1093 | 1168 | 1303 | 1372 | 1402 |
| Flexural Strength | MPa | 44 | 45 | 47 | 50 | 54 | 57 | 59 |
| DSC Tg (Second Cycle) | ° C. | 64 | 72 | 76 | 86 | 94 | 102 | 109 |
| Visual Clarity | | Clear | Clear | Clear | Clear | Clear | Clear | Clear |

### Comparative Example 1

The aliphatic-aromatic copolyester used is commercially available as Eastar Copolyester 6763 from Eastman Chemical Company. Its inherent viscosity was 0.75. The aliphatic polyester used contained 1,4 cyclohexanedimethanol (30.4 mol % cis isomer) and 1,4 cyclohexane dicarboxylicacid (7.2 mol % cis isomer) and had a measured inherent viscosity of 0.94.

The aliphatic-aromatic copolyester was dried at 70° C. and the aliphatic polyester was dried at 70° C. Blends were prepared in a 19 mm Leistritz twin screw extruder. The polyesters were premixed by tumble blending and fed into the extruder and the extruded strand was pelletized. The pellets were injection molded into parts on a Toyo 90 injection molding machine. The extruder was run at 350 rpms at a feed rate to give a machine torque between 80-100%. Processing temperatures used were in the range of 240° C. to 260° C. The compositions and properties of the blends are shown in Table 3.

TABLE 3

| | UNITS | | | | | | | |
|---|---|---|---|---|---|---|---|---|
| Weight % Eastar Copolyester | % | 100 | 85 | 70 | 50 | 30 | 15 | 0 |
| 6763 | | | | | | | | |
| Weight % Aliphatic polyester | % | 0 | 15 | 30 | 50 | 70 | 85 | 100 |
| Heat Deflection Temperature | (deg C.) | 64 | 62 | 62 | 58 | 56 | 56 | 53 |
| 264 Psi | | | | | | | | |
| Tensile Strength | MPa | 51 | 49 | 46 | 43 | 40 | 38 | 36 |
| Tensile Break Elongation | % | 88 | 106 | 241 | 437 | 325 | 429 | 411 |
| Flexural Modulus | MPa | 1829 | 1739 | NT | 1381 | 1236 | 1124 | 1011 |
| Flexural Strength | MPa | 68 | 64 | NT | 54 | 50 | 47 | 44 |
| DSC Tg (Second Cycle) | ° C. | 83 | 83 | 83 | 82 | 83 | 82 | 63 |
| | | | | 71 | 70 | 70 | 68 | |
| Visual Clarity | | Clear | Opaque | Opaque | Opaque | Opaque | Opaque | Clear |

NT = NOT TESTED

### Comparative Example 2

The aliphatic-aromatic copolyester used contained terephthalic acid, 25.1 mol % 2,2,4,4, tetramethyl-1,3 cyclobutanediol (50.1% cis isomer), 74.9% cyclohexanedimethanol. The inherent viscosity was measured to be 0.66. This aliphatic-aromatic copoplyester was blended with the Eastar Copolyester 6763.

The aliphatic-aromatic copolyester was dried at 90° C. and the copolyester 6763 was dried at 70° C. Blends were prepared in a 19 mm Leistritz twin screw extruder. The polyesters were premixed by tumble blending and fed into the extruder and the extruded strand was pelletized. The pellets were injection molded into parts on a Toyo 90 injection molding machine. The extruder was run at 350 rpms at a feed rate to give a machine torque between 80-100%. Processing temperatures used were in the range of 240° C. to 260° C. The compositions and properties of the blends are shown in Table 4.

TABLE 4

| | UNITS | | | | | | | |
|---|---|---|---|---|---|---|---|---|
| Weight % Eastar Copolyester | % | 100 | 85 | 70 | 50 | 30 | 15 | 0 |
| 6763 | | | | | | | | |
| Weight % Aliphatic polyester | % | 0 | 15 | 30 | 50 | 70 | 85 | 100 |
| Heat Deflection Temperature 264 Psi | (deg C.) | 64 | 65 | 65 | 69 | 73 | 76 | 81 |
| Tensile Strength | MPa | 51 | 50 | 48 | 47 | 46 | 46 | 44 |
| Tensile Break Elongation | % | 88 | 155 | 245 | 204 | 159 | 183 | 152 |
| Flexural Modulus | MPa | 1829 | 1781 | NT | 1665 | 1608 | 1525 | 1402 |
| Flexural Strength | MPa | 68 | 67 | NT | 65 | 64 | 63 | 59 |
| DSC Tg (Second Cycle) | ° C. | 83 | 82 | 82 | 83 | 83 | 82 | 109 |
| | | | | 108 | 107 | 106 | 105 | |
| Visual Clarity | | Clear | Hazy | Opaque | Opaque | Hazy | Hazy | Clear |

NT = NOT TESTED

The invention has been described in detail with reference to the embodiments disclosed herein, but it will be understood that variations and modifications can be effected within the spirit and scope of the invention.

1. A polymer blend comprising:
(A) 10 to 90 weight % of at least one aliphatic-aromatic copolyester which comprises:
(i) a dicarboxylic acid component comprising 70 to 100 mole % terephthalic acid residues; and
(ii) a glycol component comprising:
(a) 5 to 100 mole % of 2,2,4,4-tetramethyl-1,3-cyclobutanediol residues; and
(b) 0 to 95 mole % of cyclohexanedimethanol residues;
wherein the total mole % of the dicarboxylic acid component is 100 mole % and wherein the total mole % of the glycol component is 100 mole %; and
(B) 10 to 90 weight % of at least one aliphatic polyester which comprises:
(i) a dicarboxylic acid component comprising
(a) 70 to 100 mole % of cyclohexanedicarboxylic acid residues; and
(b) 0 to 30 mole % of additional aliphatic acid residues;
(c) 0 to 10 mole % of aromatic acid residues; and
(ii) a glycol component comprising cyclohexanedimethanol residues;
wherein the total mole % of the dicarboxylic acid component is 100 mole % and wherein the total mole % of the glycol component is 100 mole %, wherein the blend is clear.

2. The polymer blend according to claim 1 wherein said aliphatic polyester further comprises one or more aliphatic dicarboxylic acids selected from succinic, adipic, glutaric, azelaic, sebacic acids.

3. The polymer blend according to claim 1 wherein said aliphatic polyester further comprises residues of at least one dicarboxylic acid selected from terephthalic acid and isophthalic acid.

4. The polymer blend according to claim 1 wherein said aliphatic-aromatic polyester comprises 0 to 20 mole percent of the residues of 2,2,4,4-tetramethyl-1,3-cyclobutanediol, and 80 to 100 mole percent of the residues of 1,4-cyclohexanedimethanol.

5. The polymer blend according to claim 1 wherein said aliphatic-aromatic polyester comprises 20 to 40 mole percent of the residues of 2,2,4,4-tetramethyl-1,3-cyclobutanediol, and 60 to 80 mole percent of the residues of 1,4-cyclohexanedimethanol.

6. The polymer blend according to claim 1 wherein said aliphatic-aromatic polyester comprises 20 to 35 mole percent of the residues of 2,2,4,4-tetramethyl-1,3-cyclobutanediol, and 65 to 80 mole percent of the residues of 1,4-cyclohexanedimethanol.

7. The polymer blend according to claim 1 wherein said aliphatic-aromatic polyester comprises 20 to 30 mole percent of the residues of 2,2,4,4-tetramethyl-1,3-cyclobutanediol, and 70 to 80 mole percent of the residues of 1,4-cyclohexanedimethanol.

8. The polymer blend according to claim 1 wherein said aliphatic-aromatic polyester comprises 30 to 40 mole percent of the residues of 2,2,4,4-tetramethyl-1,3-cyclobutanediol, and 60 to 70 mole percent of the residues of 1,4-cyclohexanedimethanol.

9. The polymer blend according to claim 1 wherein said inherent viscosity of said aliphatic-aromatic polyester is about 0.5 to about 0.80 dL/g.

10. The polymer blend according to any of claims 1 and 5 wherein said inherent viscosity of said aliphatic-aromatic polyester is about 0.55 to about 0.75 dL/g.

11. The polymer blend according to claim 6 wherein said inherent viscosity of said aliphatic-aromatic polyester is about 0.55 to about 0.68 dL/g.

12. The polymer blend according to claim 8 wherein said inherent viscosity of said aliphatic-aromatic polyester is about 0.60 to about 0.68 dL/g.

13. The polymer blend according to claim 7 wherein said inherent viscosity of said aliphatic-aromatic polyester is about 0.65 to about 0.75 dL/g.

14. The polymer blend according to claim 8 wherein said inherent viscosity of said aliphatic-aromatic polyester copolyester is about 0.60 to about 0.70 dL/g.

15. The polymer blend according to claim 6 wherein said aliphatic-aromatic polyester has a glass transition temperature of about 100 to about 120° C.

16. The polymer blend according to claim 15 wherein said aliphatic-aromatic polyester has a glass transition temperature of about 105 to about 120° C.

17. The polymer blend according to claim 1 wherein said aliphatic polyester consists essentially of residues of cyclohexanedicarboxylic acid and residues of cyclohexanedimethanol.

18. The polymer blend of claim 1 comprising 10 to 50 weight % of said at least one aliphatic-aromatic polyester and 50 to 90 weight % of said at least one aliphatic polyester, wherein the total weight % of the aliphatic-aromatic polyester and the aliphatic polyester equals 100 weight %.

19. The polymer blend of claim 1 wherein said aliphatic-aromatic copolyester comprises phosphorus atoms.

20. A polymer blend comprising:
(A) 10 to 90 weight % of at least one aliphatic-aromatic copolyester which comprises:
(i) a dicarboxylic acid component comprising 70 to 100 mole % terephthalic acid residues; and
(ii) a glycol component comprising:
(a) 15 to 50 mole % of 2,2,4,4-tetramethyl-1,3-cyclobutanediol residues; and
(b) 50 to 85 mole % of cyclohexanedimethanol residues;
wherein the total mole % of the dicarboxylic acid component is 100 mole % and
wherein the total mole % of the glycol component is 100 mole %; and
(B) 10 to 90 weight % of at least one aliphatic polyester which comprises:
(i) a dicarboxylic acid component comprising
(a) 70 to 100 mole % of cyclohexanedicarboxylic acid residues; and
(b) 0 to 30 mole % of additional aliphatic acid residues;
(c) 0 to 10 mole % of aromatic acid residues; and
(ii) a glycol component comprising 80 to 100 mole % cyclohexanedimethanol residues and 0 to 20 mole % 2,2,4,4-tetramethyl-1,3-cyclobutanediol residues;
wherein the total mole % of the dicarboxylic acid component is 100 mole % and
wherein the total mole % of the glycol component is 100 mole %, wherein the blend is clear.

21. A polymer blend comprising:
(A) 10 to 90 weight % of at least one aliphatic-aromatic copolyester which comprises:
(a) a dicarboxylic acid component comprising:
i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) about 20 to about 40 mole % 2,2,4,4-tetramethyl-1,3-cyclobutanediol residues; and
(ii) about 20 to about 40 mole % cyclohexanedimethanol residues;
iii) ethylene glycol residues, and
(iv) less than about 2 mole % of a modifying glycol having from 3 to 16 carbon atoms;
wherein the total mole % of the dicarboxylic acid component is 100 mole %, and
wherein the total mole % of the glycol component is 100 mole %;
wherein the sum of the mole percentages of 2,2,4,4-tetramethyl-1,3-cyclobutanediol and cyclohexanedimethanol is from 40 to less than 70 mole % of the total mole % of the glycol component, and
wherein the inherent viscosity of the polyester is from 0.50 to 1.2 dL/g as determined in 60/40 (wt/wt) phenol/tetrachloroethane at a concentration of 0.25 g/50 ml at 25° C.; and
(B) 10 to 90 weight % of at least one aliphatic polyester which comprises:
(i) a dicarboxylic acid component comprising
(a) 70 to 100 mole % of cyclohexanedicarboxylic acid residues; and
(b) 0 to 30 mole % of additional aliphatic acid residues;
(c) 0 to 10 mole % of aromatic acid residues; and
(ii) a glycol component comprising cyclohexanedimethanol residues and 2,2,4,4-tetramethyl-1,3-cyclobutanediol residues;
wherein the total mole % of the dicarboxylic acid component is 100 mole % and wherein the total mole % of the glycol component is 100 mole %, wherein the blend is clear.
